(19) United States
(12) Patent Application Publication
(10) Pub. No.: US 2006/0191476 A1
(43) Pub. Date: Aug. 31, 2006

(54) Coating system for forming protective layer

(76) Inventors: Bansei Nagase, Saitama-ken (JP); Hiromi Okubo, Saitama-ken (JP); Masahito Terabe, Saitama-ken (JP); Ichiro Hamasato, Saitama-ken (JP)

Correspondence Address: FISH & RICHARDSON P.C., P.O. BOX 1022, MINNEAPOLIS, MN, 55440-1022, US

(21) Appl. No.: 10/548,458

(22) PCT Filed: Feb. 20, 2004
(86) PCT No.: PCT/JP04/02018

§ 371 Date: Aug. 17, 2005

(30) Foreign Application Priority Data
Feb. 21, 2003 (JP) 2003-044235
Feb. 21, 2003 (JP) 2003-043931
Feb. 21, 2003 (JP) 2003-043969
Feb. 21, 2003 (JP) 2003-044505
Mar. 5, 2003 (JP) 2003-058526

(51) Int. Cl. B05C 1/06; B05C 11/00

(52) U.S. Cl. 118/258; 118/264; 118/244

(57) ABSTRACT

A coating system using a protective layer forming material includes a coating device which is movable according to information taught by an operator, and disposed adjacent to a transport line for an object to be coated. The coating system includes a roller mechanism having a roller and a cushion mechanism. The roller is connected to the coating device. The coating system further includes a supply mechanism which supplies liquid material to the roller. The liquid material is dried to form a peelable protective layer on the object. A force is applied to the roller on an external surface of the object through the cushion mechanism. The roller is lifted and lowered corresponding to unevenness of the external surface.

### TECHNICAL FIELD

The present invention relates to a coating system which applies protective layer forming material to primarily the painted regions of the external surface of a vehicle which has already completed painting, and in particular relates to a coating system which applies liquid protective layer forming material which acts as a peelable protective layer after drying.

### BACKGROUND ART

Vehicles such as automobiles are often stored outdoors in stock yards after manufacturing and are transported by a trailer and a ship, or the like, before being delivered to the consumer. During this time, there is a possibility that during the long storage and transportation period, the quality of the surface layer of the multiple paint layers on the external surface of the vehicle may be damaged by dust, metallic powder, salt, oils, acid, and exposure to direct sunlight, or the like. In order to prevent this condition, methods are known where a peelable protective layer is formed on the painted region prior to shipment of the vehicle (see Japanese Laid-Open Patent Publication No. 2001-89697 for instance). A peelable protective layer is formed by applying a protective layer forming material, which is a liquid wrap material (also known as strippable paint), and then drying so that the painted region can be protected. Furthermore, the layer can be easily peeled off for removal, and yet will not peel off by itself during normal storage.

The process of applying the protective layer forming material before the peelable protective layer is dried consists of applying protective layer forming material to a roller and having several operators rotating the rollers to apply the protective layer forming material.

In order to automate this operation so that the burden on operators can be reduced and coating quality can be consistent, a method has been proposed wherein after protective layer forming material has been extracted onto a vehicle body, the protective layer forming material is spread out by applying an air blow from an air nozzle (see Japanese Laid-Open Patent Publication No. 08-173882). Using this method, many of the operations of the coating process are automated, the operator's burden is lightened, and takt time can be improved.

Furthermore, in a factory where vehicles are manufactured, a plastic cover known as a scratch cover may be temporarily applied to the vehicle body for preventing scratches during the assembly process. A scratch cover is, for instance, temporarily applied to the front and side surfaces of the vehicle body and then removed prior to shipping. A different shape of scratch cover must be prepared for every vehicle type, and it is also necessary to prepare multiple scratch covers depending on the number of vehicles produced each day on the transport line.

However, with the method disclosed in Japanese Laid-Open Patent Publication No. 08-173882, the protective layer forming material is not always spread uniformly, and protective layer forming material is not applied to the edges of the roof in order to prevent scattering of the material.

Furthermore, recent automobile bodies have more complicated configurations with recessed and raised regions and complicated intricate curved surfaces. It is difficult to spread protective layer forming material using an air nozzle in these recessed and raised regions and on curved surfaces. Moreover, there is a need to apply protective layer forming material thicker in areas where the painting quality is particularly important, but it is difficult to adjust the thickness of the applied coating when protective layer forming material is spread by an air nozzle.

Therefore, after protective layer forming material has been spread out by an air nozzle, multiple operators must finish up by applying protective layer forming material by a roller to the edges of the roof and to intricate regions such as recessed and raised regions. Therefore, the process of applying protective layer forming material is still partly dependent on manual operations, which is a burden on operators, and the coating quality may vary depending on the skills of the operators.

In order to reduce the work of operators and make the quality of the operation consistent, the use of industrial robots has been investigated, but rollers appropriate for applying protective layer forming material and retention equipment for such, which can be attached to robots has not been proposed. Furthermore, because recent vehicle bodies have shapes with complicated intricate curves as described above, a special construction is necessary in order for the roller to be in close contact with the vehicle body. It is, of course, preferable that the roller has a simple structure.

Furthermore, when the roller is pressed to the external surface of the vehicle and protective layer forming material is applied, it is preferable that the weight of the roller be effectively used as the pressing force, assisted by an appropriate means when the pressing force from the roller weight is insufficient. On one hand, when the roller is pressed to the external surface of the vehicle and protective layer forming material is applied, it is preferable that degrees of freedom of the application path is large such that the roller can rotate and move both in a clockwise direction and a counterclockwise direction.

Also, it is preferable to have an actuator which stops the compensating press force depending on the shape of the external surface of the vehicle and the motion of the robot, and a lock to keep the roller from changing position.

Furthermore, it is preferred that the pressing force is easily adjustable depending on the location of application and the movement method. Also, if the roller is movable, it is preferable to have a lock to prevent movement depending on the condition of use.

### DISCLOSURE OF INVENTION

An object of the present invention is to provide a coating system which can further automate the process of applying protective layer forming material to the external surface of an object being coated, and can keep the roller in close contact with the external surface of the object being coated in order to appropriately apply protective layer forming material.

Another object of the present invention is to provide a coating system which can easily adjust the pressing force of the roller on the external surface of the object to be coated depending on the application area and movement method, and which can also be locked depending on the condition of use.

Yet another object of the present invention is to provide a coating system wherein motion teaching of the coating device can easily be carried out.

Still another object of the present invention is to provide a coating system with a simple structure which can keep the roller in close contact with the external surface of the object being coated.

A coating system of the present invention is disposed adjacent to a transport line for the object to be coated, and comprises a coating device which is movable according to information taught by an operator, and a roller mechanism having a roller and a cushion mechanism. The roller is connected to the coating device. The coating system further comprises a supply mechanism which supplies liquid material to the roller. A force is applied to the roller through the cushion mechanism to move the roller corresponding to the unevenness (the recessed and raised regions) of an external surface of the object for coating the object with the liquid material. The liquid material is dried to form a peelable protective layer on the object.

Since the roller mechanism has the cushion mechanism, the roller can be kept in close contact with the external surface of the object to be coated, and protective layer forming material can be applied appropriately. The roller can even be kept in close contact with the external surface in areas where there are some recessed and raised regions. Therefore, the process of applying protective layer forming material to the external surface of the object to be coated can be further automated.

In this case, if the coating device is a robot and the object to be coated is a vehicle, the robot can suitably move along the complicated shape of the vehicle.

The roller mechanism may have a press force adjusting mechanism which adjusts the pressing force of the roller on the external surface. With the press force adjusting mechanism, the roller can be pressed to the external surface of the object to be coated with an appropriate pressing force, free rotation of the roller can be prevented, and the roller can be prevented from jumping and skipping in reaction to recessed and raised regions.

Also, the roller mechanism may have a pivoting mechanism which connects the roller in a manner which can freely pivot, in addition to its ability to freely rotate about the roller's longitudinal axis.

By allowing the roller to pivot freely with the pivoting mechanism, with the simple structure, the roller can be kept in close contact with the external surface of the object to be coated, and protective layer forming material can be appropriately applied. Therefore, the process of applying protective layer forming material to the external surface of an object to be coated can be further automated.

In this case, if the pivoting mechanism is connected to allow the roller to pivot freely in a radial direction, the roller passively pivots depending on the recessed and raised regions of the external surface of the object being coated. The roller is kept in close contact with the surface of the object easily.

Furthermore, the roller mechanism is equipped with a pneumatic cylinder as the cushion mechanism, and the roller may be elastically pressed to the external surface of the object to be coated through the pneumatic cylinder while the roller is passively raised and lowered depending on the raised and recessed regions of the external surface.

If protective layer forming material is applied while applying pressure to the roller using a pneumatic cylinder in this manner, the roller can be kept in close contact with the external surface of the object to be coated, and protective layer forming material can be appropriately applied. In other words, the roller can be kept in close contact with the external surface even in areas where there are some recessed and raised regions. Therefore, the process of applying protective layer forming material to the external surface of the object to be coated can be further automated.

In this case, a regulator may be provided to adjust the air pressure supplied to the pneumatic cylinder.

By adjusting the air pressure supplied to the pneumatic cylinder using the regulator, the roller pressure can be easily adjusted depending on the region of application and the method of movement. Furthermore, the roller can be locked to prevent movement depending on the condition of use.

If the center axis of the rod of the pneumatic cylinder is orthogonal to the center axis of the roller, the roller can easily be pressed to the external surface of the object to be coated.

The pneumatic cylinder may include a first pneumatic cylinder and a second pneumatic cylinder, and the roller is connected to a pivoting member in a manner which can pivot freely in the radial direction. The first pneumatic cylinder and the second pneumatic cylinder each applies pressure in opposing directions on the pivoting member.

By allowing the roller to pivot freely in this manner and by applying pressing forces in opposite directions by the first pneumatic cylinder and the second pneumatic cylinder, the weight of the roller can be effectively utilized as a pressing force, and when the pressing force from the roller weight is insufficient, compensation is possible using the first pneumatic cylinder. Furthermore, the first pneumatic cylinder and the second pneumatic cylinder each applies a pressing force in the opposite direction on the pivoting member, so suitable movement is possible even when the pivoting member is angled to one side.

Furthermore, a controller may be provided to control the coating device and the roller mechanism. The roller is connected to the locking member in a manner which can freely pivot in the radial direction, and the roller mechanism may include a first pneumatic cylinder and a second pneumatic cylinder which move in opposing directions with regards to the pivoting member. The controller performs a switching operation between a first control condition where a rod of the first pneumatic cylinder and/or the second pneumatic cylinder creates a first drive force which presses the pivoting member in an angled direction, and a second control condition where a second drive force separates the rod from the pivoting member, adjusting to the movement of the coating device.

In this manner, the process of applying protective layer forming material to the external surface of an object to be coated can be further automated by individually switching between the first control condition and the second control condition for first pneumatic cylinder and second pneumatic cylinder. Furthermore, the weight of the roller can effectively be used as a pressing force, and if necessary, when the pressing force of the roller weight is insufficient, compensation can be made using the first pneumatic cylinder or the second pneumatic cylinder. Furthermore, by switching between the control conditions of, first pneumatic cylinder and second pneumatic cylinder, the roller can rotate in either a clockwise or counterclockwise direction.

In this case, in order to match the coating device movement, the controller also controls by switching to a third control condition which locks the pivoting member by creating a third drive force on both the first pneumatic cylinder and the second pneumatic cylinder, and the third drive force should be larger than the first drive force. The pivoting member can be locked by the third control condition.

Furthermore, in the first control condition, if the controller makes the rod retract, then the pressure bearing surface area becomes the total surface area of the cylinder piston minus the surface area of the rod, so the first drive force can be small.

Also, a first drive setting component controlled by the controller may be provided. The first drive setting component sets the drive force and drive direction of the first pneumatic cylinder, and a second drive setting component which is controlled by the controller and sets the drive force and drive direction of the second pneumatic cylinder. Since the first drive setting component and second drive setting component are provided separately, first pneumatic cylinder and second pneumatic cylinder can be independently controlled, and control procedures is simplified.

If the first pneumatic cylinder and/or the second pneumatic cylinder have a regulator which sets the pneumatic pressure for creating the first drive force and/or the second drive force, then the first drive force and/or the second drive force can be set to the appropriate level.

Next, the roller mechanism should have a thrust rotating mechanism which is connected in a manner which can freely rotate with a center axis which is orthogonal to the center axis of the roller. Furthermore, the roller mechanism should have a longitudinal pivoting mechanism which is connected in a manner which can freely pivot in the longitudinal direction of the roller.

With this type of thrust rotating mechanism or pivoting mechanism, the process of applying protective layer forming material to the external surface of an object for coating the object can be further automated. Furthermore, the roller can always be kept in close contact with the external surface of the object to be coated and at the same time, the motion teaching of the coating device can be easily carried out. Moreover, excessive force can be prevented on either the roller or the external surface of the object to be coated.

In this case, the roller mechanism may also have a pivoting mechanism which is connected to the roller to enable free pivoting in the radial direction. Since the pivoting mechanism is provided, the roller can move three dimensionally, and can be kept in even closer contact with the external surface of the object to be coated.

If the protective layer forming material uses an acrylic type copolymer, the painted region of the object to be coated can be more positively protected, and peeling is easy when the layer is to be removed.

The above and other objects, features and advantages of the present invention will become more apparent from the following description when taken in conjunction with the accompanying drawings in which preferred embodiments of the present invention are shown by way of illustrative example.

### BRIEF DESCRIPTION OF DRAWINGS

FIG. 1 is a perspective view of a coating system according to an embodiment of the present invention.

FIG. 2 is a front elevational view of the coating system.

FIG. 3 is a perspective view of a robot having the coating system and a roller mechanism.

FIG. 4 is an expanded perspective view of a roller mechanism of the coating system.

FIG. 5 is a partial cross-section expanded front view of the roller mechanism.

FIG. 6 is a partial cross-section expanded side view of the roller mechanism.

FIG. 7 is a circuit diagram showing a complex circuit of the coating system for hydraulic and pneumatic pressure.

FIG. 8 is a circuit diagram for a pneumatic cylinder circuit of the coating system using bold lines to show the primary flow of air when the robot is moved to the right while applying protective layer forming material.

FIG. 9 is a schematic diagram showing the positional relationship of a robot and the surface of a vehicle for the process where a robot equipped with a roller mechanism is moved to the right.

FIG. 10 is a schematic side elevational view showing the positional relationship of a robot and the external surface of a vehicle when a robot equipped with a roller mechanism is moved to the left.

FIG. 11 is a circuit diagram for the pneumatic cylinder circuit using bold lines to show the primary flow of air when the robot is moved to the left while applying protective layer forming material.

FIG. 12 is a schematic side elevational view showing the positional relationship of a robot and the external surface of a vehicle when the rods of left and right pneumatic cylinders on the roller mechanism are both retracted while protective layer forming material is applied.

FIG. 13 is a schematic side elevational view showing the positional relationship of a robot and the external surface of a vehicle when the rods of the left and right pneumatic cylinders on the roller mechanism are both extended while protective layer forming material is applied.

FIG. 14 is a circuit diagram of the pneumatic cylinder circuit using bold lines to show the primary flow of air when the rods of the left and right pneumatic cylinders in the roller mechanism are both extended.

FIG. 15 is a schematic side elevational view showing the positional relationship between a robot and the external surface of a vehicle when the rods of the left and right pneumatic cylinders in the roller mechanism are both retracted with a strong force while protective layer forming material is applied.

FIG. 16 is a circuit diagram of the pneumatic cylinder circuit using bold lines to show the primary flow of air when the rods of the left and right pneumatic cylinders in the roller mechanism are both retracted with a strong force.

FIG. 17 is a side elevational view of a roller mechanism equipped with a pin pressing member of a different configuration according to the invention.

FIG. 18 is a schematic diagram showing the condition where the angle of the external surface of a vehicle does not match the direction of the roller.

FIG. 19 is a schematic diagram showing the condition where the roller rotates around the center axis, and the angle of the external surface of the vehicle matches the direction of the roller.

FIG. 20 is a schematic diagram showing the condition where the roller moves and the angle of the external surface of the vehicle matches the direction of the roller.

FIG. 21 is a schematic diagram showing the condition where the angle of the external surface of the vehicle continuously changes and the bottom surface of the roller rotates while in contact with the surface of the vehicle by the joint action of a thrust rotating mechanism and a first pivoting axle.

FIG. 22 is a front elevational view of a roller mechanism according to a first alternate embodiment of the invention.

FIG. 23 is a schematic diagram of the roller mechanism according to the first alternate embodiment, showing the condition where the roller moves and the angle of the external surface of the vehicle matches the direction of the roller.

FIG. 24 is a perspective view of a roller mechanism according to a second alternate embodiment of the invention.

FIG. 25 is a schematic diagram showing the positional relationship between the roller mechanism and the external surface of the vehicle during the process where motion teaching of the robot is carried out.

FIG. 26 is a perspective view of a roller mechanism according to a third alternate embodiment of the invention.

FIG. 27 is a perspective view of a roller mechanism according to a fourth alternate embodiment of the invention.

FIG. 28 is a schematic diagram showing the positional relationship of the roller mechanism and the external surface of the vehicle according to the fourth alternate embodiment during the process where motion teaching of the robot is carried out.

FIG. 29 is a perspective view of a roller mechanism according to a fifth alternate embodiment of the invention.

FIG. 30 is a schematic diagram showing the positional relationship of the roller mechanism and the external surface of a vehicle according to the fifth alternate embodiment during the process where motion teaching of the robot is carried out.

FIG. 31 is a perspective view of a roller mechanism according to a sixth alternate embodiment of the invention.

FIG. 32 is a perspective view of a roller mechanism according to a seventh alternate embodiment of the invention.

### BEST MODE FOR CARRYING OUT THE INVENTION

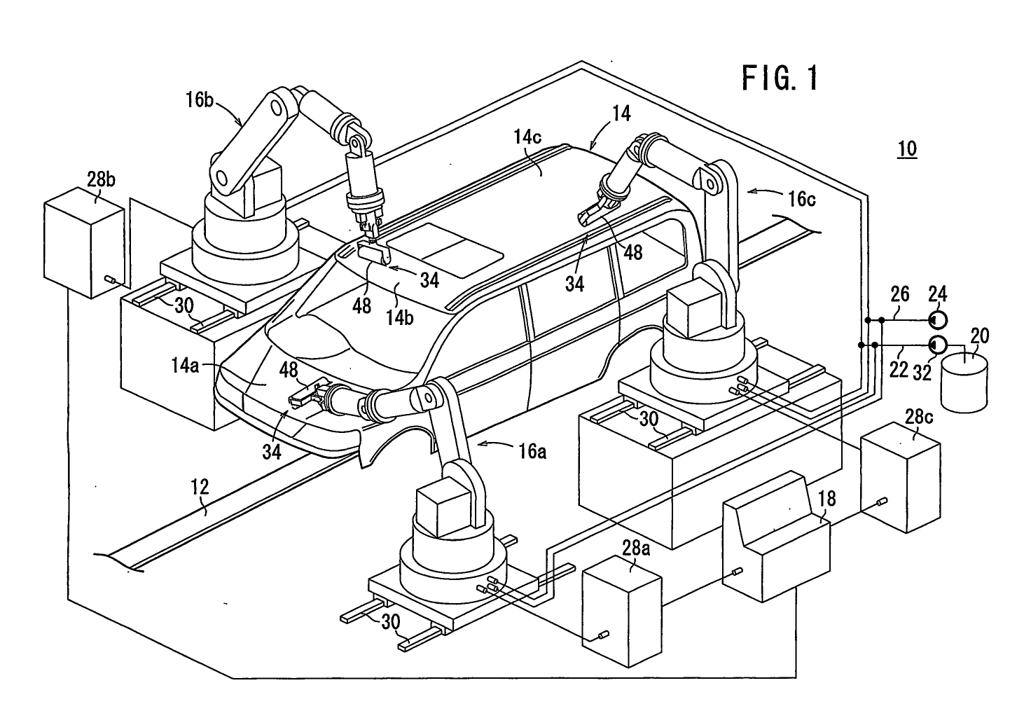

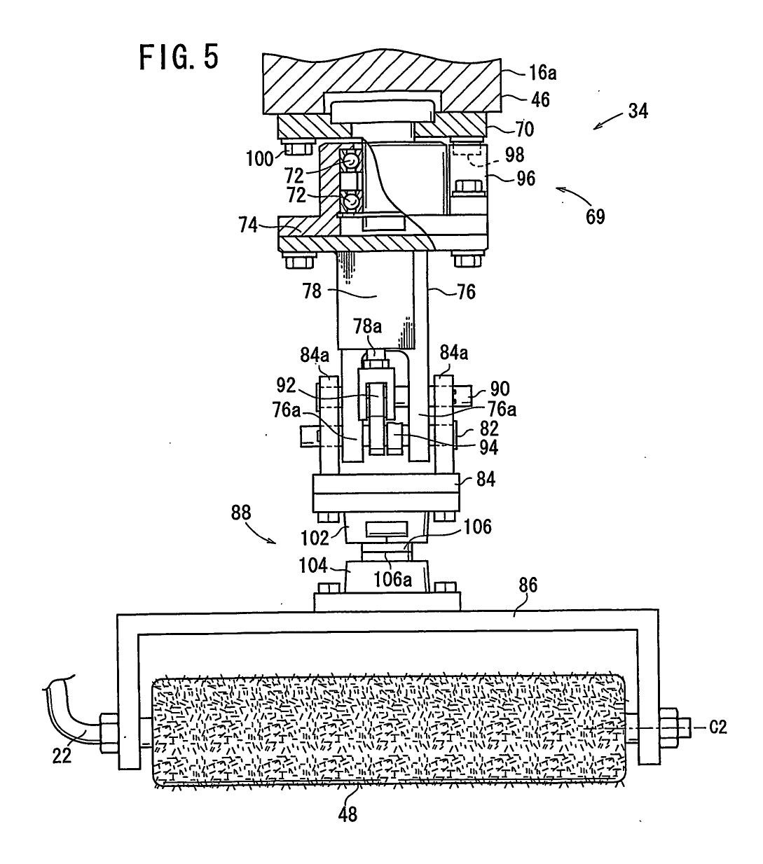

A coating system for forming a protective layer of the present invention will be described below by presenting embodiments with reference to FIG. 1 through FIG. 32.

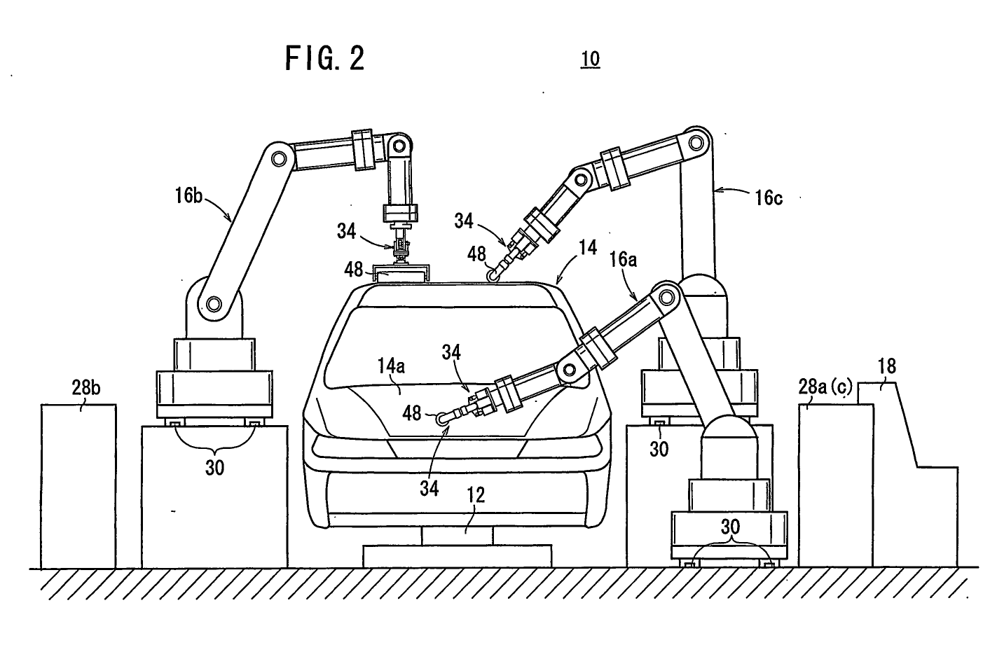

As shown in FIG. 1 and FIG. 2, a coating system 10 of an embodiment according to the invention is disposed on a transport line 12 of a vehicle (object to be coated) 14, and coats a vehicle 14 with protective layer forming material after painting is completed. The coating system 10 comprises three industrial robots (coating device) 16a, 16b, 16c, a controller 18 which controls the entire system, a tank 20 which stores the protective layer forming material, a tube 22 which connects the tank 20 to each of the robots 16a, 16b, 16c, and a water tube 26 which provides water to the robots 16a, 16b, 16c. The robots 16a, 16b, 16c are controlled by the robot controllers 28a, 28b, 28c which are all connected to the controller 18.

The robots 16a and 16c are disposed on the left of the transport line 12 in the moving direction of the vehicle 14, and the robot 16b is on the right. Furthermore, the robot 16a is disposed forward in the moving direction, the robot 16c disposed backward, and the robot 16b disposed near the middle of the robot 16a and the robot 16c. The robots 16a, 16b, 16c are movable along a slide rail 30 which is in parallel with the transport line 12.

A pump 32 is provided along the tube 22, and sucks the protective layer forming material from tank 20 and supplies the material to the robots 16a, 16b, 16c. Furthermore, the protective layer forming material is controlled at an appropriate temperature by a heater and thermometer not shown in the drawings. Roller mechanisms 34 are provided at the end of each of the robots 16a, 16b, 16c, and are each provided with the protective layer forming material through the tube 22.

The protective layer forming material includes an acrylic base copolymer as a major component, and preferably has two types of acrylic base copolymers with different glass transition temperatures. Specifically, the protective layer forming material shown in Japanese Laid-Open Patent Publication No. 2001-89697 may be used. Furthermore, the viscosity of the protective layer forming material can be adjusted by changing the ratio of water and the temperature, and when dried, the protective layer forming material tightly adheres to the vehicle 14, and can chemically and physically protect the painted regions of the vehicle 14 from dust, metallic powder, salt, oil, acids, and direct sunlight or the like. Furthermore, the material can easily be peeled off from the vehicle 14 when delivered to the user.

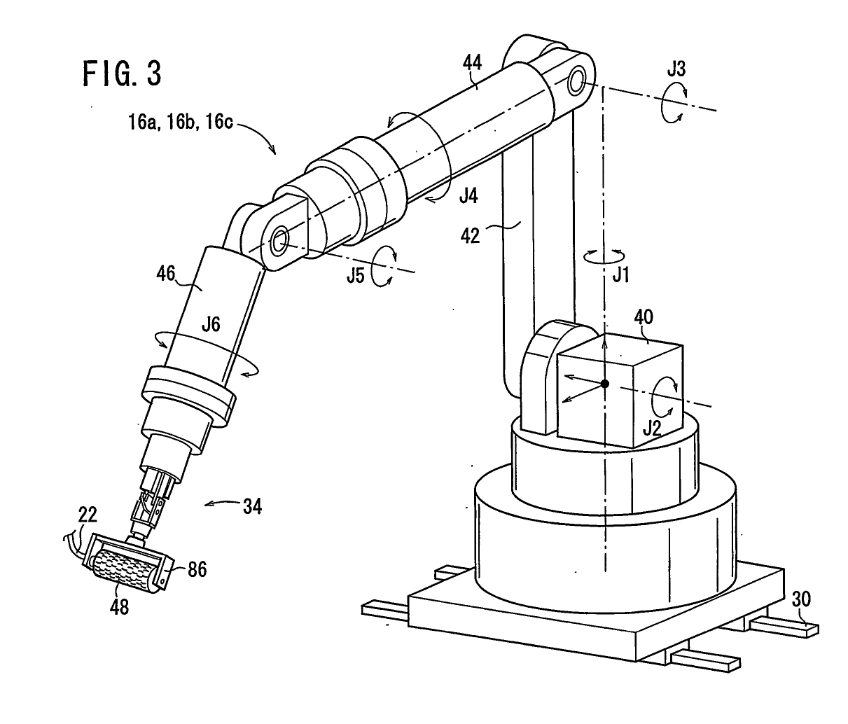

As shown in FIG. 3, each of the robots 16a, 16b, 16c is an industrial multi-jointed robot, and comprises a base 40, and in order from the base 40, a first arm 42, a second arm 44, and a third arm 46. A roller mechanism 34 is provided at the tip end of the third arm 46. The roller mechanism 34 is detachably attached to the third arm 46, and can function as an end effector. The first robot arm 42 is able to rotate by using rotatable axes J1, J2 which are horizontal and perpendicular to the base 40. The second arm 44 is connected to the first arm 42 in a manner which can rotate around an axis J3. The second arm 44 is able to twist around an axis J4. The third arm 46 is connected to the second arm 44 in a manner which can rotate around an axis J5. The third arm 46 is able to twist around an axis J6.

Because of the movement of these six-axis-structured robots 16a, 16b, 16c, the roller mechanism 34 which is connected to the tip end is able to move in any position adjacent to the vehicle 14, and can be set at any direction. In other words, the roller mechanism 34 is able to move with six degrees of freedom. The robots 16a, 16b, 16c may also have extending and retracting motions in addition to rotating motions, and may have moving parts which are linked in parallel.

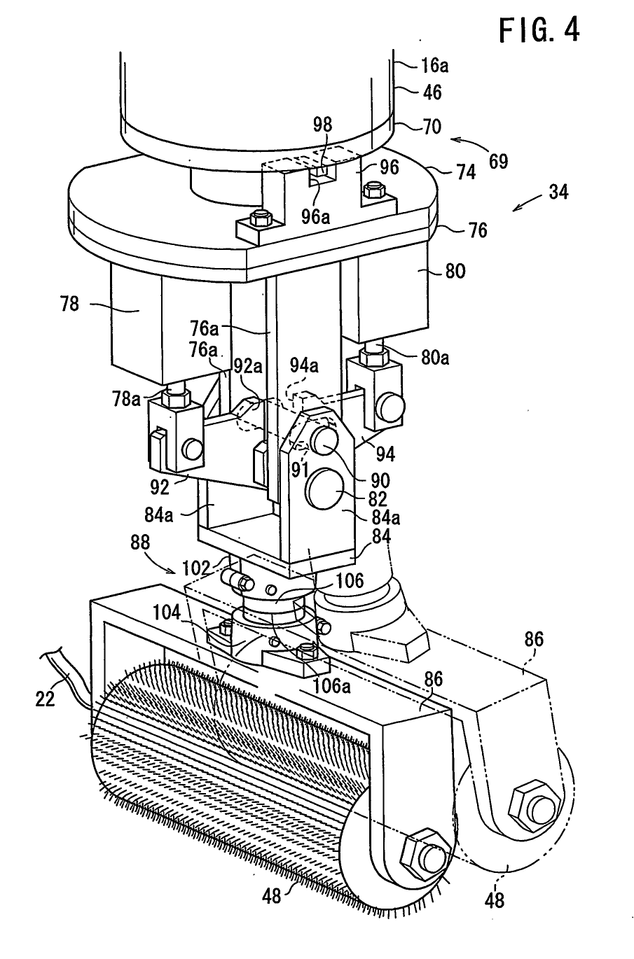

As shown in FIG. 4 through FIG. 6, the roller mechanism 34 is mounted on the tip end of the third arm 46, and comprises a cylindrical roller 48 made from a material which can absorb and retain the protective layer forming material, and a thrust rotating mechanism 69 which is the mounting part for the third arm 46 of the robot 16a.

The material of the roller 48 may be, for instance, a sponge or a nap. Furthermore, the roller 48 can be freely attached or removed from the holder 86, and can be replaced, washed, or maintained. Note that the roller 48 can be attached or removed from roller mechanisms 34a-34g which are discussed later.

The thrust rotating mechanism 69 comprises a mounting member 70 for the third arm 46, a thrust rotating member 74 which is supported in a manner which can freely rotate with regard to the mounting member 70 through a bearing 72, and a base 76 which is attached to the bottom of the thrust rotating member 74.

Furthermore, the roller mechanism 34 comprises a first pneumatic cylinder 78 and a second pneumatic cylinder 80 which are provided on both sides of the base 76, a first pivoting member 84 which is supported in a manner which can freely pivot, to a first pivot shaft roughly below the base 76, and a holder connector 88 which connects the first pivoting member 84 and the holder 86 which supports the roller 48. The roller 48 is able to pivot around a first pivot shaft 82, and is able to move in a direction orthogonal to a shaft center C2. The first pivoting member 84 has two upward extenders 84a which extend upward, and the first pivot shaft 82 and a parallel pin 90 are provided roughly above the upward extenders 84a.

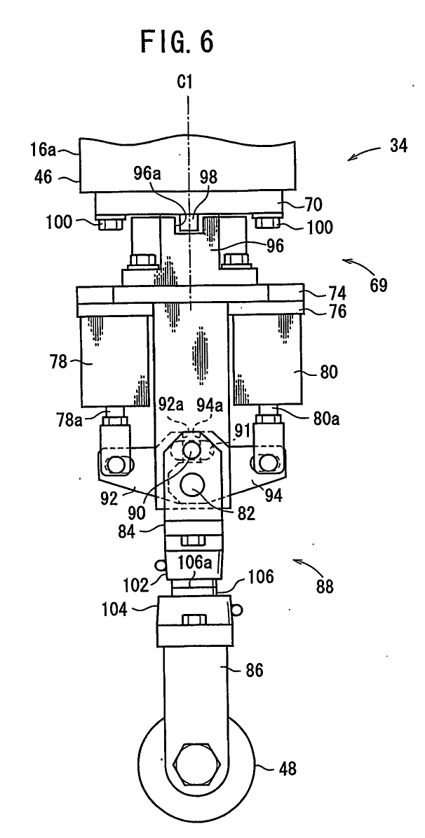

The pin 90 is inserted in a manner which can freely move into a long hole 91 formed in a lower extender 76a above the first pivot shaft 82. Furthermore, the roller mechanism 34 receives pressure from a rod 78a and a rod 80a of the first pneumatic cylinder 78 and the second pneumatic cylinder 80, and has two pin pressing members 92 and 94 which rotate around the first pivot shaft 82. The pressing surface 92a of the pin pressing member 92 presses the left side of the pin 90 shown in FIG. 6 when the rod 78a is retracted, and a pressing surface 94a of the pin pressing member 94 presses the tight side of the pin 90 shown in FIG. 6 when the rod 80a is retracted.

The two downward extenders 76a are positioned to extend downward from the base 76 between the two upward extenders 84a, and the pressing surfaces 92a and 94a are positioned between the two downward extenders 76a.

The thrust rotating member 74 has a rotation regulating member 96, and a small protrusion 98 which protrudes downward from the mounting member 70 is positioned in the recessed region 96a on the top surface of the rotation regulating member 96. The width of the small protrusion 98 is slightly smaller than the width of recessed region 96a and the thrust rotating member 74 is able to rotate freely in the direction of thrust to the extent of this gap. The direction of thrust in this document is the direction orthogonal to the center axis of the roller 48, and is the rotational direction about a center axis C1 of the third arm 46. A bolt 100 which is used to attach the mounting member 70 to the third arm 46 may also be used as the small protrusion 98.

The holder connector 88 has two opposing clamps 102 and 104 provided on the top and bottom thereof. These clamps 102 and 104 support an aluminum pipe 106, and the first pivoting member 84 and the holder 86 are connected together by the aluminum pipe 106. The surface of the aluminum pipe 106 has a circular groove 106a.

Both ends of the roller 48 are supported in a manner which can freely rotate by the holder 86, and the tube 22 is connected to the inside of the roller 48 through one end of the holder 86. The roller 48 is detachably attached to the holder 86.

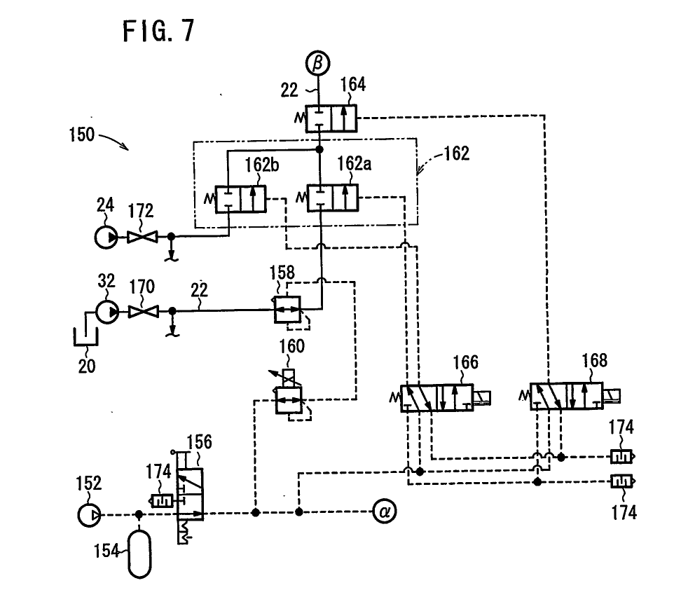

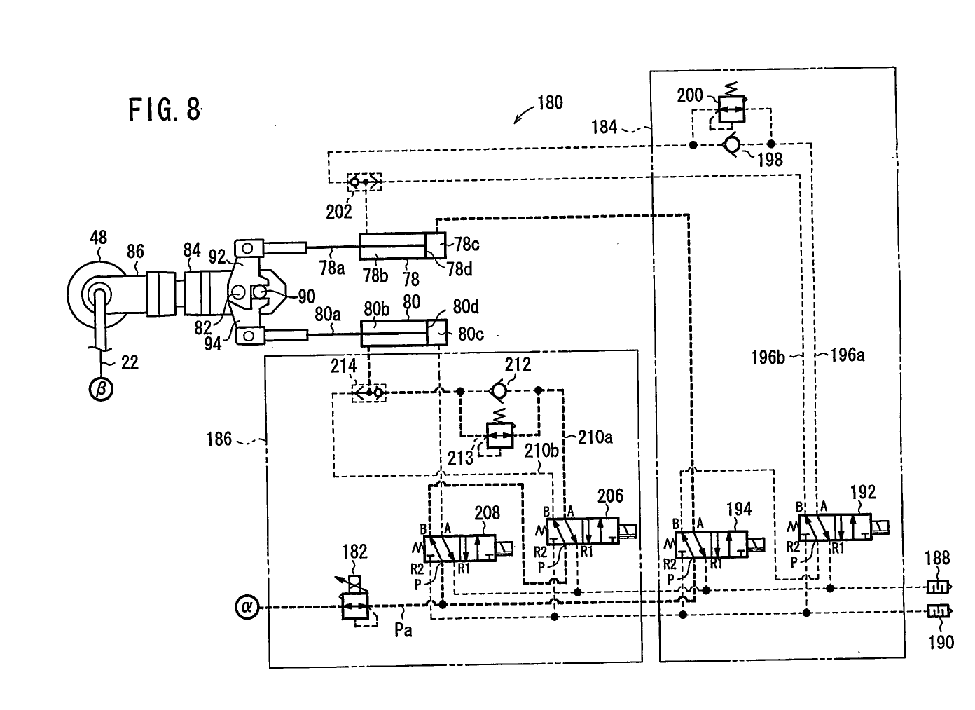

As shown in FIG. 7, a hydraulic and pneumatic complex circuit (supply mechanism) 150, which supplies the protective layer forming material to the roller 48 (see FIG. 8), has a compressor 152, an air tank 154 which is connected to the discharge port of the compressor 152, a manual pneumatic on-off valve 156 which switches on and off of pneumatic air, a regulator 158 which reduces the secondary pressure based on an electric signal provided from the controller 18, and a regulator operating valve 160 which reduces the pressure in the tube 22 by pilot operation using the secondary pressure from the regulator 158.

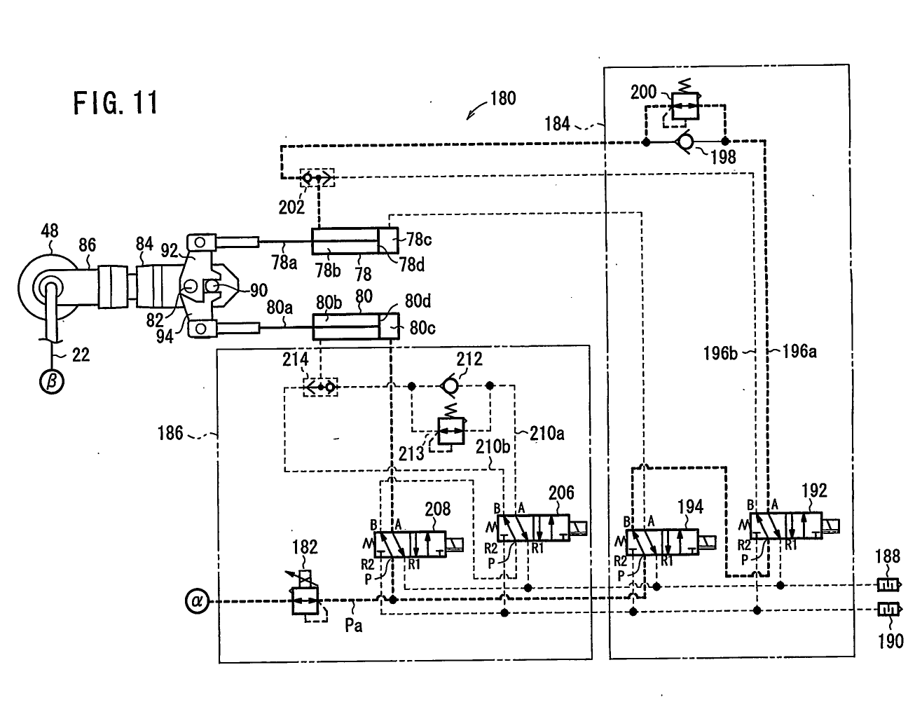

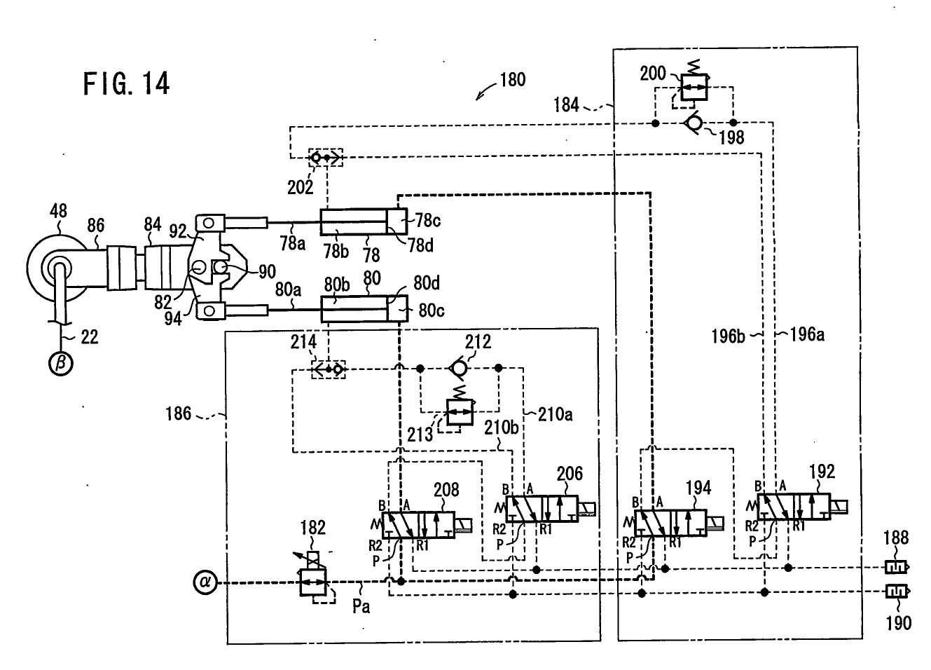

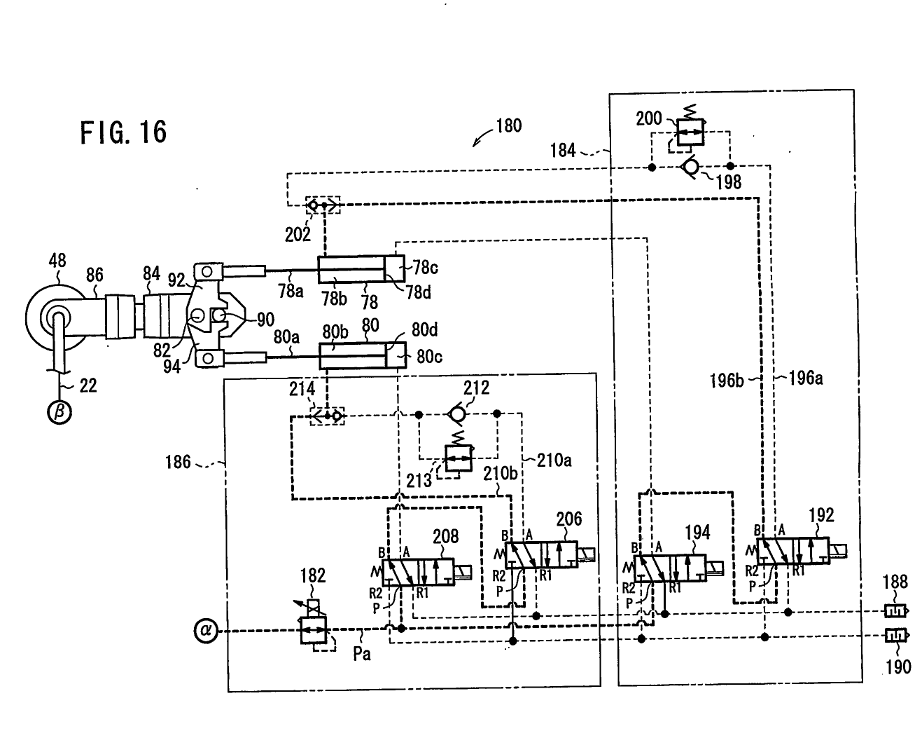

Furthermore, the complex circuit 150 also has a material control valve (MCV) 162 which is connected with the tube on the secondary side of the regulator operating valve 160 with the water tube 26, and a trigger valve 164 which is disposed between the secondary side of the MCV 162 and the roller 48 (see FIG. 8). In the MCV 162, there are switching valves 162a, 162b which switch between on and off of the tube 22 and the water tube 26. The secondary sides of the switching valves 162a, 162b are connected with each other. Note that the pneumatic tube is shown by a broken line in FIG. 7, FIG. 8, FIG. 11, FIG. 14, and FIG. 16.

The MCV 162, the trigger valve 164, and the regulator operating valve 160 are not limited to pneumatic pilot type valves. An electric solenoid or the like may be used alternatively.

The complex circuit 150 also has an MCV switching electromagnetic valve 166 which operates switching valves 162a, 162b using a pilot operation by the switching of pneumatic air supplied from the pneumatic on-off valve 156, and a trigger switching electromagnetic valve 168 which pilots the trigger valve 164. The MCV switching electromagnetic valve 166 connects to either one of switching valves 162a, or 162b and is cut off from the other, depending on the electric signal supplied from the controller 18, and switches between water and the protective layer forming material supplied to the trigger valve 164. The trigger switching electromagnetic valve 168 switches between on and off of the trigger valve 164 by an electric signal provided from the controller 18, and supplies either water or the protective layer forming material to the roller 48.

Manual cut off valves 170, 172 are provided along the tube 22 and water tube 26. Normally, the valves 170 and 172 are communicated with each other. Silencers 174 are provided on all of the pneumatic discharge ports in the complex circuit 150 in order to reduce the exhaust noise. The compressor 152, the pump 32, and a water source 24 all have relief valves (not shown in the drawing) to prevent excessive pressure rise.

The compressor 152, the air tank 154, the water source 24, and the pump 32 in the complex circuit 150 are common to the robots 16a, 16b, 16c, and all other devices are equipped separately for each of the robots 16a, 16b, 16c. Furthermore, the tubes “α” and “β” in FIG. 7 are connected respectively to the tubes “α” and “β” of a pneumatic cylinder circuit 180 shown in FIG. 8, FIG. 11, FIG. 14, and FIG. 16.

As shown in FIG. 8, the pneumatic cylinder circuit 180, which drives the first pneumatic cylinder 78 and the second pneumatic cylinder 80, has a regulator 182 which reduces the air pressure provided to a designated pressure Pa, a first drive setting component 184 which sets the driving force and drive direction of the first pneumatic cylinder 78, and a second drive setting component 186 which sets the driving force and drive direction of the second pneumatic cylinder 80. The pressure Pa set by the regulators 182 is a relatively high pressure within the rated operating pressure range of the first pneumatic cylinder 78 and the second pneumatic cylinder 80. The pneumatic cylinder circuit 180 is equipped on each of the robot 16a, 16b, 16c.

Air from the pneumatic on-off valve 156 (see FIG. 7) is supplied to the regulators 182, and air with pressure reduced to the pressure Pa by the regulators 182 is guided to the first drive setting component 184 and the second drive setting component 186. Silencers 188 and 190 are connected to the first drive setting component 184 and the second drive setting component 186 as air exhaust ports.

The first drive setting component 184 has a first rod pressure switching electromagnetic valve 192 which has an effect of switching the pneumatic pressure inside a first chamber 78b of the first pneumatic cylinder 78, and a first bottom pressure switching electromagnetic valve 194 which has the effect of switching the pneumatic pressure inside a second chamber 78c of the first pneumatic cylinder 78. The first chamber 78b is closer to the rod 78a than to a piston 78d in the cylinder tube, and the second chamber 78c is opposite to the first chamber 78b with regard to the piston 78d.

The first rod pressure switching electromagnetic valve 192, the first bottom pressure switching electromagnetic valve 194, and a later mentioned second rod pressure switching electromagnetic valve 206, and a second bottom pressure switching electromagnetic valve 208 are each equipped with five ports, namely a port A, a port B, a port P, a port R1, and a port R2. These electromagnetic valves are controlled and switched by the controller 18, and in the un-energized state, the port A is connected to the port R1 and the port B is connected to the port P, while the port R2 is closed. Furthermore, in the energized state, the port A is connected to the port P, and the port B is connected to the port R2, while the port R1 is closed. Each of the ports R1 can freely exhaust air through the silencer 188, and each of the ports R2 can freely exhaust air through the silencer 190.

Furthermore, the first drive setting component 184 comprises a check valve 198 which is disposed on the tube 196a which is one of the two tubes 196a and 196b connecting the first chamber 78b with the first rod pressure switching electromagnetic valve 192, a regulator 200 which is provided in parallel with the check valve 198, and a shuttle valve 202 which connects either one of the tube 196a or 196b that has higher pressure to the first chamber. The check valve 198 moves air from the first chamber 78b toward the first rod pressure switching electromagnetic valve 192, and blocks the flow of air in the opposite direction.

The port A and the port B of the first rod pressure switching electromagnetic valve 192 are connected to the tubes 196a and 196b, respectively. The port A of the first bottom pressure switching electromagnetic valve 194 is connected to the second chamber 78c. The port B of the first bottom pressure switching electromagnetic valve 194 is connected to the port P of the first rod pressure switching electromagnetic valve 192. Air set to the pressure Pa by the regulators 182 is supplied to the port P of the first bottom pressure switching electromagnetic valve 194.

The second drive setting component 186 comprises the second rod pressure switching electromagnetic valve 206 which has the effect of switching pneumatic pressure of a first chamber 80b in the second pneumatic cylinder 80, and the second bottom pressure switching electromagnetic valve 208 which has the effect of switching pneumatic pressure of a second chamber 80c of the second pneumatic cylinder 80. The first chamber 80b is the chamber closer to the rod 80a than to a piston 80d in the cylinder tube, and the second chamber 80c is opposite to the first chamber 80b with regard to the piston 80d.

Furthermore, the second drive setting component 186 comprises a check valve 212 which is disposed on a tube 210a which is one of two tubes 210a and 210b connecting the first chamber 80b with the second rod pressure switching electromagnetic valve 206, a regulator 213 which is provided in parallel with the check valve 212, and a shuttle valve 214 which connects either one of the tube 210a or 210b that has higher pressure to the first chamber. The check valve 212 moves air from the first chamber 80b toward the second rod pressure switching electromagnetic valve 206, and blocks the flow of air in the opposite direction.

The ports A and B of the second rod pressure switching electromagnetic valve 206 are connected to the tubes 210a and 210b, respectively. The port A of the second bottom pressure switching electromagnetic valve 208 is connected to the second chamber 80c. The port B of the second bottom pressure switching electromagnetic valve 208 is connected to the port P of the second rod pressure switching electromagnetic valve 206. Air set to the pressure Pa by the regulators 182 is supplied to the port P of the second bottom pressure switching electromagnetic valve 208.

By this structure of the pneumatic cylinder circuit 180, the first bottom pressure switching electromagnetic valve 194 and the second bottom pressure switching electromagnetic valve 208 are energized to supply air at the pressure Pa which is a relatively high pressure supplied from the regulators 182 to both of the second chamber 78c and the second chamber 80c.

Furthermore, when the first bottom pressure switching electromagnetic valve 194 is not energized, the first rod pressure switching electromagnetic valve 192 can supply air to the first chamber 78b by being energized. At this time, the pressure of air supplied to the first chamber 78b is set to a low value by the regulator 200. When the second bottom pressure switching electromagnetic valve 208 is not energized, the second rod pressure switching electromagnetic valve 206 can supply air to the first chamber 80b by being energized. At this time, the pressure of the air supplied to the first chamber 80b is set to a low value by the regulator 213.

Furthermore, when both of the first bottom pressure switching electromagnetic valve 194 and the first rod pressure switching electromagnetic valve 192 are not energized, air at the pressure Pa set by the regulators 182 can be supplied to the first chamber 78b. When both of the second bottom pressure switching electromagnetic valve 208 and the second rod pressure switching electromagnetic valve 206 are not energized, air with the pressure of Pa set by the regulators 182 can be supplied to the first chamber 80b.

Next, the method of applying the protective layer forming material to the vehicle 14 using the coating system 10 will be described.

First, the motion of each of the robots 16a, 16b, 16c is taught beforehand. The robots 16a, 16b, 16c are assigned to the hood region 14a (see FIG. 1), the roof center region 14b, and the roof rear region 14c of the vehicle 14, respectively. The robots 16a, 16b, 16c are taught to coat their respective regions with the protective layer forming material, and the teaching data is recorded and stored by the designated recorder of the controller 18. When the vehicle 14 is a sedan, the robot 16c is assigned to a trunk region.

By controlling the pressure from the regulator 158, the operating speed of the robots 16a, 16b, 16c, and the pressure added to the rod 78a and the rod 80a, the thickness of the protective layer forming material on the vehicle 14 can be adjusted.

Of course the vehicle 14 may be an unfinished vehicle without some components, but at least the painting is completed.

The vehicle 14 coated with the protective layer forming material by the robots 16a, 16b, 16c is transported to the next process by the transport line 12. The robots 16a, 16b, 16c retract to a standby position in which the robots 16a, 16b, 16c do not interfere with the vehicle 14, and wait until a next vehicle 14 is transported. At this time, the trigger valve 164 is closed and the supply of the protective layer forming material is stopped.

The protective layer forming material which has been applied to the vehicle 14 is naturally dried, or dried using forced air, to form a peelable protective layer, and thus the painted region of the vehicle 14 is protected.

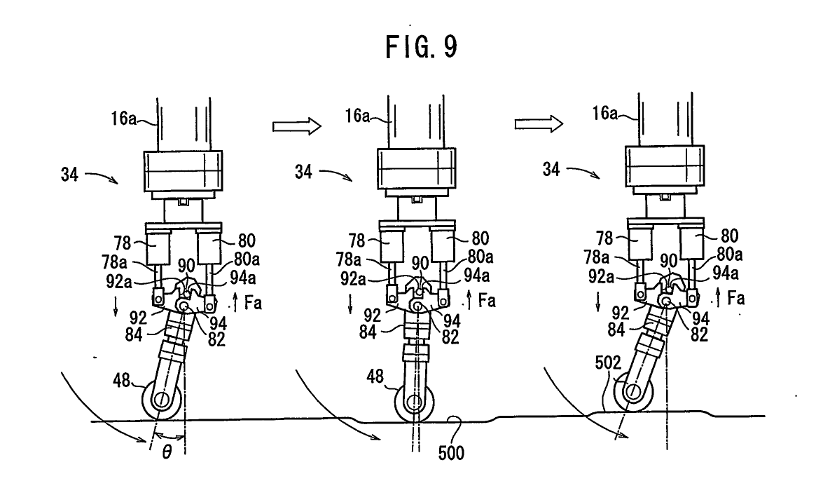

As shown in FIG. 9, when the motion of the robot 16a which is equipped with the roller mechanism 34 is taught, an appropriate distance is maintained between the third arm 46 of the robot 16a and the external surface of the vehicle 14. The angle of the first pivoting member 84 is taught to a designated angle θ. The angle of the first pivoting member 84 is basically maintained at the angle θ. But for instance, the operator may omit a recessed region 500 and a raised region 502 in teaching if the angle of the first pivoting member 84 can change slightly. By omitting these shallow recessed regions 500 and relatively low raised regions 502, the motion teaching of the robot 16a can be simplified.

The process of applying the protective layer forming material to the vehicle 14 shall be taught to be completed within a takt time set for each of the vehicles 14 on the transport line 12.

Next, when the protective layer forming material is applied to the vehicle 14, the tube 22 is heated to an appropriate temperature, and the compressor 152, the water supply source 24, and the pump 32 are operated. Furthermore, the robots 16a, 16b, 16c are in the standby position in which the robots 16a, 16b, 16c do not interfere with the vehicle 14, and the pneumatic on-off valve 156 is open.

Next, the vehicle 14 on which painting is completed is conveyed by the transport line 12, and is stopped near the robots 16a, 16b, 16c. The controller 18 learns that the vehicle 14 is conveyed either by a signal provided from the transport line 12 or from a sensor (not shown in drawings), and the robots 16a, 16b, 16c are moved based on the teaching data.

At this time, the controller 18 regulates the regulator operating valve 160 through the regulator 158 (see FIG. 7), and the tube 22 is regulated to an appropriate pressure. Furthermore, the controller 18 controls the MCV 162 through the MCV switching electromagnetic valve 166, connecting tube 22 while closing the water tube 26. Also, the controller 18 opens the trigger valve 164 by the operation of the trigger switching electromagnetic valve 168. By the operation of the controller 18 in this manner, the protective layer forming material is maintained at an appropriate pressure and a temperature while being supplied to the roller 48 of the roller mechanism 34, and the appropriate quantity of the protective layer forming material permeates from the backside of the roller 48.

Next, when the protective layer forming material is applied to the vehicle 14 while the robot 16a moves to the right (see FIG. 9), air is supplied to the second pneumatic cylinder 80 on the right (first control) so that a relatively weak force (first drive force) Fa is generated in the direction to retract the rod 80a. Furthermore, air is supplied to the first pneumatic cylinder 78 on the left (second control) in order to extend the rod 78a. By doing this, the pressing surface 94a of the pin pressing member 94 on the right presses with a relatively weak force the right surface of the pin 90, and the pressing surface 92a of the pin pressing member 92 on the left is separated from the pin 90. Therefore, the first pivoting member 84 and the roller 48 receive a pressure in the counterclockwise direction around the first pivot shaft 82, and the roller 48 presses the surface of the vehicle 14 with an appropriate pressure, and the protective layer forming material can be applied while the roller 48 is rotating in the clockwise direction shown in FIG. 9. Pressure Fa can be adjusted appropriately depending on the coating location for the roller 48 and the method of movement of the roller 48.

At this time, the controller 18 excites the first bottom pressure switching electromagnetic valve 194 and the second rod pressure switching electromagnetic valve 206, and makes the second bottom pressure switching electromagnetic valve 208 non-energized. By doing this, as shown by the bold line in FIG. 8, air at the pressure Pa is supplied to the second chamber 78c of the first pneumatic cylinder 78, while air with a lower pressure which has been reduced by the regulator 213 is supplied to the first chamber 80b of the second pneumatic cylinder 80.

Furthermore, the second chamber 80c is connected to the silencer 188 through the second bottom pressure switching electromagnetic valve 208, and freely vents the air. The tubes 196a and 196b which are connected to the first chamber 78b are connected to either of the silencer 188 or 190 regardless of whether the first rod pressure switching electromagnetic valve 192 is energized or not, and are freely vented.

Thus, the relatively weak force Fa is generated in the direction that the rod 80a is retracted, while a relatively large force (second drive force) can positively extend the rod 78a. These pressures can also be adjusted by the regulators 182 and 213.

Furthermore, the second pneumatic cylinder 80 is a single rod type cylinder, and the pressure receiving surface area of the piston 80d near the first chamber 80b which has the rod 80a is smaller than the pressure receiving surface area near the second chamber 80c. Therefore, the force generated by applying pressure to the first chamber 80b and retracting the rod 80a is smaller than the force by applying pressure to the second chamber 80c and extending the rod 80a, so that the force Fa can be precisely set to a small value. Furthermore, the force applied to the roller 48 can be precisely adjusted.

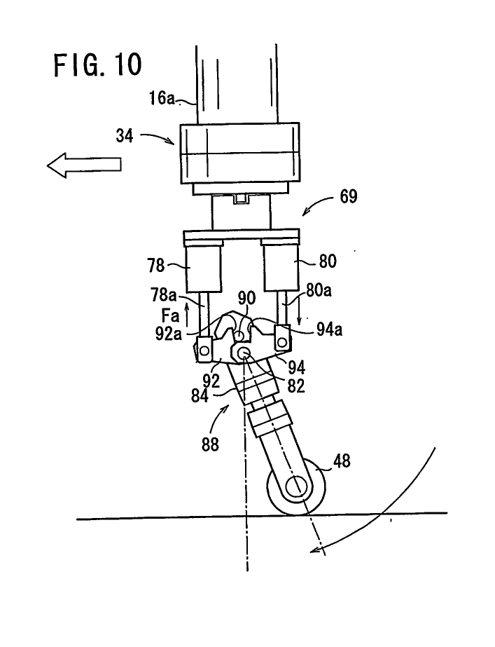

As shown in FIG. 10, when the robot 16 is moved to the left while the vehicle 14 is coated with the protective layer forming material, air is supplied to the first pneumatic cylinder 78 on the left in order to generate the relatively weak force Fa in the direction that the rod 78a retracts (first control). Furthermore, air is supplied to the second pneumatic cylinder 80 on the right (second control) in order to extend the rod 80a. By doing this, the pressing surface 92a of the left pin pressing member 92 presses with a relatively weak force the left surface of the pin 90; and the pressing surface 94a of the right pin pressing member 94 is separated from the pin 90. Therefore, the first pivoting member 84 and the roller 48 receive a pressure in the clockwise direction around the first pivot shaft 82, and the roller 48 presses the surface of the vehicle 14 with an appropriate pressure, and the surface can be coated with the protective layer forming material while the roller 48 is rotating in the counterclockwise direction shown in FIG. 10.

At this time, the controller 18 energizes the second bottom pressure switching electromagnetic valve 208 and the first rod pressure switching electromagnetic valve 192, and the first bottom pressure switching electromagnetic valve 194 is not energized. By doing this, as shown by the bold line in FIG. 11, air at the pressure Pa is supplied to the second chamber 80c of the first pneumatic cylinder 80, while air with a lower pressure which has been reduced by the regulator 200 is supplied to the first chamber 78b of the second pneumatic cylinder 78.

Furthermore, the second chamber 78c is connected to the silencer 188 through the first bottom pressure switching electromagnetic valve 194, and freely vents the air. The tubes 210a and 210b which are connected to the first chamber 80b are connected to either of the silencer 188 or 190 regardless of whether the second rod pressure switching electromagnetic valve 206 is energized or not energized, and are freely vented.

As described above, the relatively weak force Fa is generated in the direction that the rod 78a is retracted, while a relatively large force (second drive force) can positively extend the rod 80a. These pressures can also be adjusted by the regulators 182 and 200.

Furthermore, the first pneumatic cylinder 78 is a single rod type cylinder, and the pressure receiving surface area of the piston 78d near the first chamber 78b which has the rod 78a is smaller than the pressure receiving surface area near the second chamber 78c. Therefore, the force generated by applying pressure to the first chamber 78b and retracting the rod 78a is smaller than the force by applying pressure to the second chamber 78c and extending the rod 78a, so that the force Fa can be precisely set to a small value. Furthermore, the force applied to the roller 48 can be precisely adjusted.

In this manner, by controlling the pressure and direction of airflow supplied to the first pneumatic cylinder 78 and the second pneumatic cylinder 80 depending on the direction of motion of the robot 16a, the roller 48 can appropriately presses the surface of the vehicle 14. In other words, the weight of roller 48 is effectively used as a pressing force, and the force which is insufficient as the pressing force even by applying the roller weight can be compensated for by the first pneumatic cylinder 78 or the second pneumatic cylinder 80.

Therefore, the roller 48 does not spin freely and does not jump or skip when the roller 48 passes over the recessed region 500 or the raised region 502. Furthermore, the protective layer forming material easily exudes from the roller 48. At this time, the roller 48 is able to pivot around the first pivot shaft 82, so that the roller 48 can be in close contact with the recessed region 500 and the raised region 502, and these regions can be coated with the protective layer forming material. In other words, when the roller 48 passes over the recessed region 500 or the raised region 502, the rod 78a or 80a extends or contracts depending on the depth of the recessed region 500 or the height of the raised region 502. The first pneumatic cylinder 78 and the second pneumatic cylinder 80 are able to move flexibly by making use of air which is easily compressible as the drive fluid, and are able to easily absorb changes in external pressure. In other words, the first pneumatic cylinder 78 and the second pneumatic cylinder 80 function as a cushion.

Furthermore, even if the third arm 46 comes close to the surface of the vehicle 14 because the movement of the robot 16a varies slightly from the designated teaching route unexpectedly, the roller 48 moves along the surface of the vehicle 14 and the present force on the surface is controlled by the pneumatic pressure supplied to the first pneumatic cylinder 78 and the second pneumatic cylinder 80, so that excessive force will not be applied to the vehicle 14. In particular, the first and second pneumatic cylinders 78, 80 use air which is compressible as the drive fluid so that a flexible movement is available, and variations in external forces can easily be absorbed.

The pin pressing member 92 which is connected to the rod 78a of the first pneumatic cylinder 78 and the pin pressing member 94 which is connected to the rod 80a of the second pneumatic cylinder 80 apply pressing force in opposite directions to the first pivoting member 84 through the pin 90. Thus, regardless of whether pivoting member 84 is angled in the clockwise direction or in the counterclockwise direction, appropriate motion is available. Therefore, the protective layer forming material can be applied either to the left or to the right.

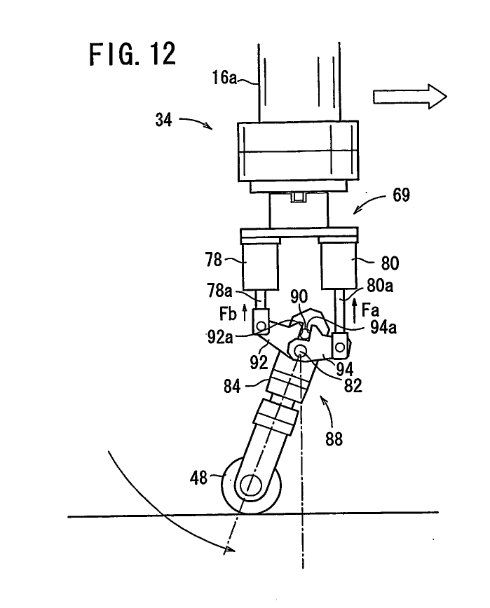

Furthermore, as shown in FIG. 12, both of the rod 78a of the first pneumatic cylinder 78 and the rod 80a of the second pneumatic cylinder 80 may be retracted. For instance, when the robot 16a is moved to the right in FIG. 12, the relatively weak force Fa is generated in the direction where the rod 80a retracts, while force Fb which is weaker than the force Fa is generated in the direction where the rod 78a retracts. When the force Fa is larger than force Fb and both of the force Fa and force Fb are set appropriately, the roller 48 can press with an appropriate force the surface of vehicle 14.

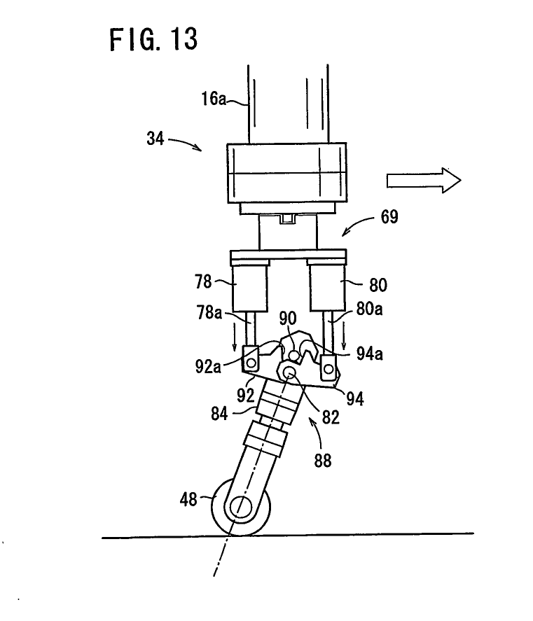

Furthermore, as shown in FIG. 13, it is also acceptable to extend both of the rod 78a of the first pneumatic cylinder 78 and the rod 80a of the second pneumatic cylinder 80. By doing this, both of the press surface 92a of the pin press member 92 and the press surface 94a of the pin pressing member 94 are removed from the pin 90, and the force does not apply to the first pivoting member 84. Therefore, the roller 48 presses the surface of the vehicle 14 only by its own weight. In particular, when the roller 48 is heavy enough to apply sufficient pressing force to the surface of the vehicle 14, both of the rod 78a and the rod 80a may be extended, so that first pivot member 84 can pivot freely.

At this time, the controller 18 energizes the first bottom pressure switching electromagnetic valve 194 and the second bottom pressure switching electromagnetic valve 208. Therefore, as shown by the bold line in FIG. 14, air with the pressure Pa is supplied to the second chamber 78c of the first pneumatic cylinder 78 and the second chamber 80c of the second pneumatic cylinder 80.

Furthermore, the tubes 196a and 196b which are connected to the first chamber 78b are connected to either of the silencer 188 or 190 regardless of whether the first rod pressure switching electromagnetic valve 192 is in the energized or not, and can vent the air freely. On the other hand, the tubes 210a and 210b which are connected to the first chamber 80b are connected to either of the silencer 188 or 190 regardless of whether the second rod pressure switching electromagnetic valve 206 is energized or not, and can vent the air freely. Therefore, as described above, the rod 78a and the rod 80a can reliably be extended.

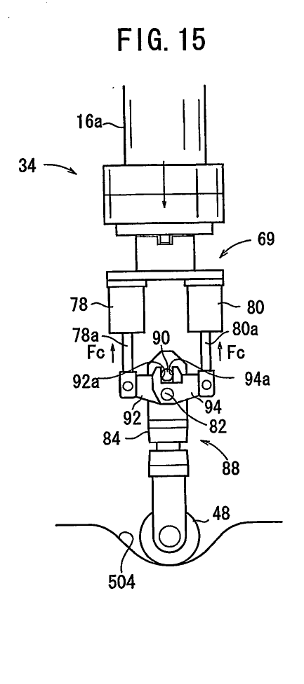

Also, as shown in FIG. 15, when the protective layer forming material is applied to a narrow and relatively, deep groove 504, both of the rod 78a and the rod 80a should be retracted by a strong force (third drive force) Fc (third control). In this case, the first pivoting member 84 will be set in the direction which matches the center axis C1 (see FIG. 6) in mechanical balance. Then, the first pivoting member 84 will hardly pivot in either the left or right direction, or in other words the first pivoting member 84 will be locked. In this manner, with the locked first pivoting member 84, the roller 48 is pressed with a relatively strong force into the groove 504, so that the protective layer forming material exudes from the roller 48 and the groove 504 can be coated with the protective layer forming material.

Furthermore, when the roller 48 is moved a relatively long-distance without contacting the surface of the vehicle 14, the first pivoting member 84 should be locked. By locking the first pivoting member 84, inadvertent pivoting does not occur, and the roller can be moved at high-speed for a long distance.

At this time, the controller 18 does not energize all the first rod pressure switching electromagnetic valve 192, the first bottom pressure switching electromagnetic valve 194, the second rod pressure switching electromagnetic valve 206, and the second bottom pressure switching electromagnetic valve 208. Therefore, as shown by the bold line in FIG. 16, air with the pressure Pa is supplied to the first chamber 78b of the first pneumatic cylinder 78 through the first bottom pressure switching electromagnetic valve 194, the first rod pressure switching electromagnetic valve 192, and the shuttle valve 202 in order. On the other hand, air with the pressure Pa is supplied to the first chamber 80b of the second pneumatic cylinder 80 through the second bottom pressure switching electromagnetic valve 208, the second rod pressure switching electromagnetic valve 206, and the shuttle valve 214 in order.

Furthermore, the second chamber 78c is connected to the silencer 188 through the first bottom pressure switching electromagnetic valve 194, and thus vents the air freely. The second chamber 80c is connected to the silencer 188 through the second bottom pressure switching electromagnetic valve 208, and thus vents the air freely.

Therefore, as described above, the rod 78a and the rod 80a can reliably be retracted by a strong force Fc.

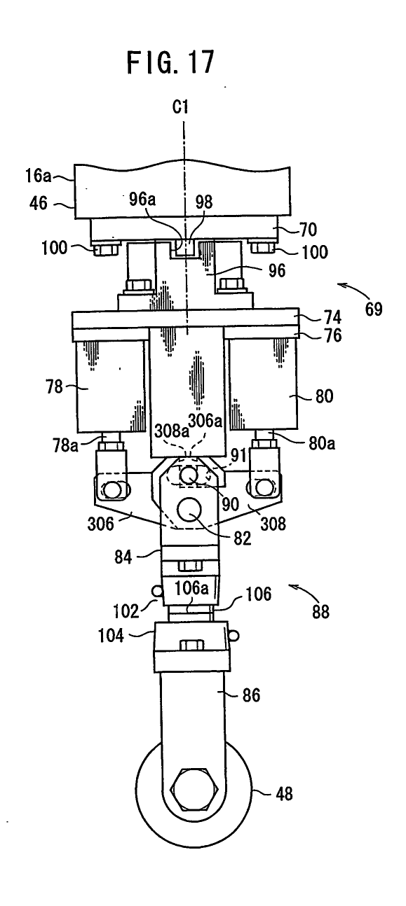

Next, as shown in FIG. 17, the pin pressing member 92 and 94 (see FIG. 4) in the roller mechanism 34 may be replaced by pin pressing members 306 and 308.

The pin pressing members 306 and 308 receive force from the rods 78a, 80a, respectively, and rotate around the first pivot shaft 82. The pressing surface 306a of the pin pressing member 306 presses the right surface of the pin 90 in FIG. 16 when the rod 78a is extended, and pressing surface 308a of the pin pressing member 308 presses the left surface of the pin 90 in FIG. 17 when the rod 80a is extended. By this type of structure, the force which extends the rod 78a and the rod 80a can be controlled, and the pressing force on the roller 48 can be adjusted. In this case, the directions of force applied to the rod 78a and the rod 80a are opposite to those when the pin pressing members 92 and 94 are used.

Furthermore, in the pneumatic cylinder circuit 180 (see FIG. 8) which drives the first pneumatic cylinder 78 and the second pneumatic cylinder 80 of the roller mechanism 34, the tube connected to the first chamber 78b and the tube connected to the second chamber 78c may be connected reversely, and the tube connecting first chamber 80b and the tube connecting the second chamber 80c may also be connected reversely. Therefore, the pressure applied to the rod 78a and the rod 80a can be in the reverse direction.

As described above, in the coating system 10 of this preferred embodiment, the roller mechanism 34 or 34a which is equipped with the roller 48 is operated by the robots 16a, 16b, 16c, and the protective layer forming material is supplied to the roller 48. The process of coating the protective layer forming material can be automated, and consistent quality of coating can be achieved.

Furthermore, the process of coating the protective layer forming material on the surface of the vehicle 14 can be more automated than conventional technology, and the roller 48 can always be kept in close contact with the surface of the vehicle 14. Furthermore, the motion of the robots 16a, 16b, 16c can be easily taught.

Also, the roller mechanisms 34, 34a have a function which presses the roller 48 on the surface of the vehicle 14, while moving the roller 48, corresponding to the unevenness, so that the roller 48 can be kept in close contact with the outer surface of the vehicle 14, and the protective layer forming material can be coated appropriately.

Furthermore, because the process of coating the protective layer forming material by operators is eliminated by automation, the number of processes is reduced and production efficiency can be increased. Also, air conditioning equipment for operators can be omitted. Therefore, energy can be saved by a reduction in the power required for air conditioning, and the plant can become more environmentally friendly while reducing operating costs.

On one hand, the peelable protective layer formed by the protective layer forming material can protect the painted regions of the vehicle 14 on delivery, and the layer also serves as a scratch cover which can protect the painted surfaces in the plant. Therefore, many scratch covers having various configurations for each vehicle type can be omitted.

The bumper of the vehicle 14 may be colored, or may not require painting, but protective layer forming material may also be applied to not-painted regions such as bumpers.

Furthermore, the object to be coated with protective layer forming material may of course be objects such as road 20, signs or billboards. The equipment for coating protective layer forming material is not restricted to the robots 16a, 16b, 16c, and of course any device whose motion can be taught may be used.

Furthermore, the pressing force of the roller 48 on the surface of the vehicle 14 is set by the pneumatic pressure supplied to the first pneumatic cylinder 78 and the second pneumatic cylinder 80. Therefore, by keeping constant pneumatic pressures, changes in pressing force over time can be prevented, and variations in the coating quality of protective layer forming material can be prevented.

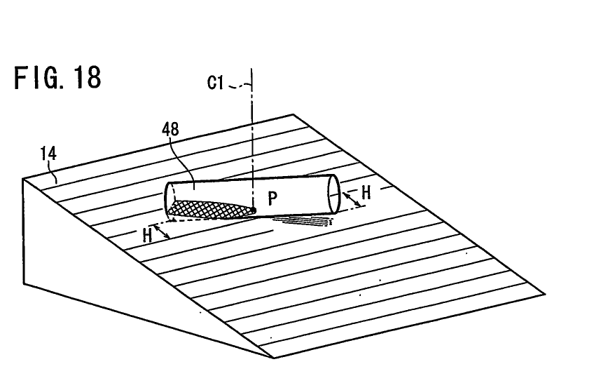

Next, the effect of the thrust rotating mechanism 69 will be described with reference to FIG. 18 through FIG. 21.

As shown in FIG. 18, when the angle of the slope of the surface of the vehicle 14 does not match the direction of the roller 48, if the thrust rotating mechanism 69 which comprises the bearing 72 and the thrust rotating member 74 (see FIG. 4) is not provided, only a center point P of the bottom part of the roller 48 contacts the surface of the vehicle 14, and both ends of the roller 48 will be separated in the horizontal direction from the surface of the vehicle 14 by a distance H, or else there will be interference.

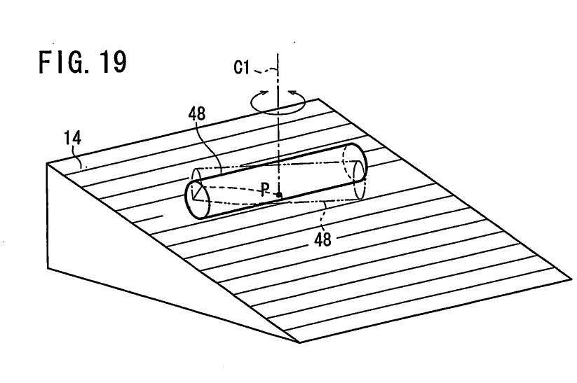

However, because the roller mechanism 34 is equipped with the thrust rotating mechanism 69, as shown in FIG. 19, the roller 48 will rotate around the center axis C1, and the bottom surface of the roller 48 will automatically come in close contact with the surface of the vehicle 14. Therefore, the protective layer forming material ban more accurately be coated on the surface of the vehicle 14. Furthermore, the roller 48 will not excessively press the surface of the vehicle 14, and excessive force on both of the roller 48 and the surface of the vehicle 14 can be prevented.

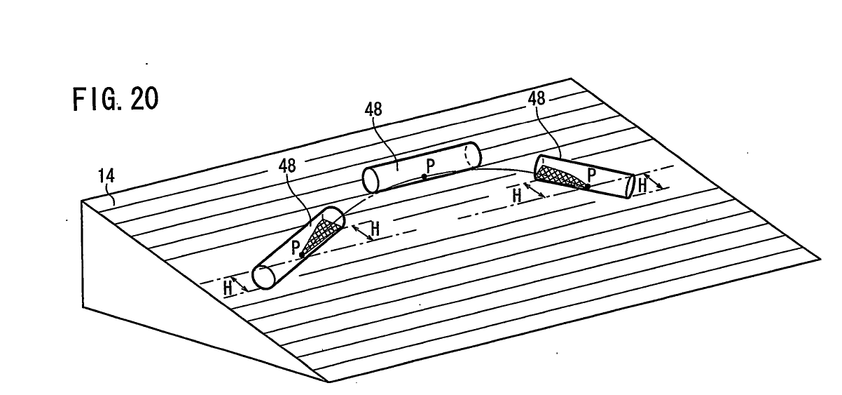

Furthermore, considering that the first pivoting member 84 (see FIG. 4) is angled about the first pivot shaft 82, as shown in FIG. 20, the bottom surface of the roller 48 will move three-dimensionally along and be in close contact with the surface of the vehicle 14. In other words, by operating the thrust rotating mechanism 69 and the first pivot shaft 82 together, the bottom surface of the roller 48 can be kept in close contact with the surface of the vehicle 14.

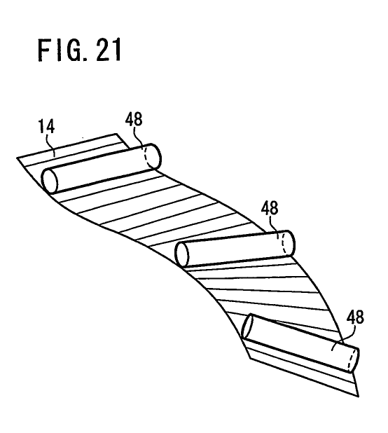

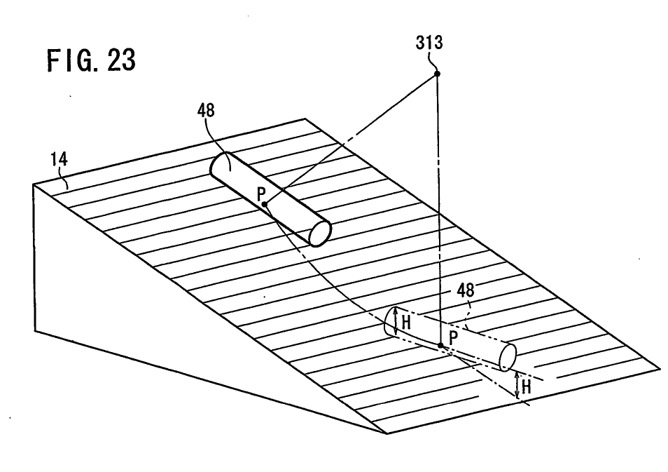

As shown in FIG. 21, even when the angle of the surface of the vehicle 14 continuously changes, the bottom surface of the roller 48 can rotate while contacting the surface of the vehicle 14 because of the coordinated movement of the thrust rotating mechanism 69 and the first pivot shaft 82. The contour lines on the surface of the vehicle 14 shown in FIG. 18, FIG. 19, FIG. 20, FIG. 21, and later mentioned FIG. 23 are added so that the incline of the three-dimensional surface can easily be understood.

In this manner, even if the angle of inclination of the surface of the vehicle 14 does not match the direction of the roller 48, the bottom surface of the roller 48 will automatically be in close contact with the surface of the vehicle 14, so that the protective layer forming material can more accurately be coated on the surface of the vehicle 14, and the movement of the robot 16a may be set relatively roughly. Therefore, the motion teaching of the robot 16a can be performed easily, and the time required for teaching can be reduced.

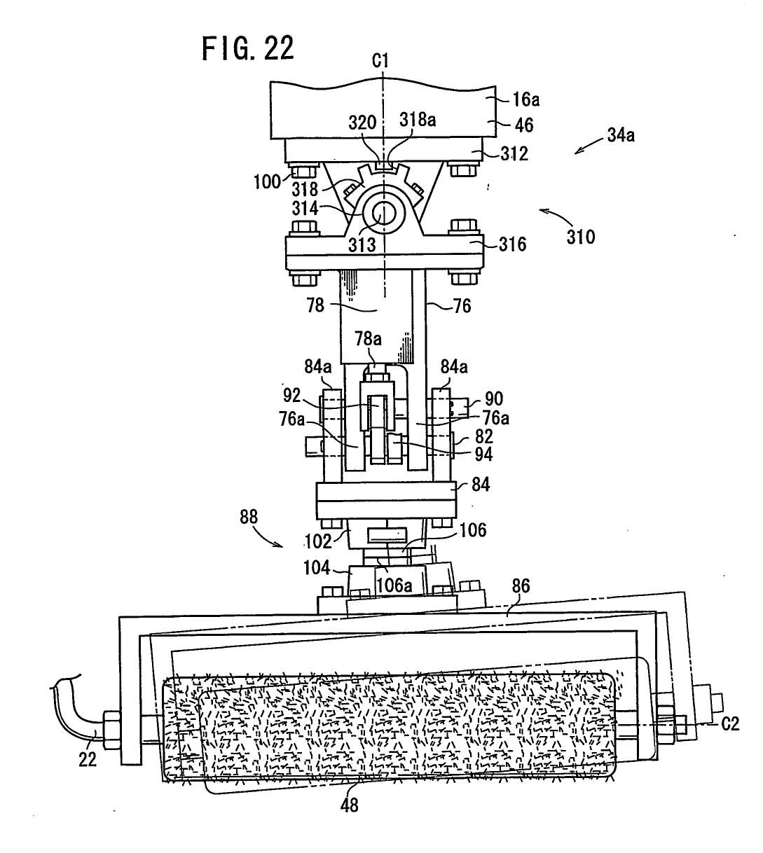

Next, roller mechanisms 34a-34g according to first through seventh alternate embodiment of the roller mechanism 34 will be described with reference to FIG. 22 through FIG. 32. The constituent elements that are identical to those of the roller mechanism 34 are labeled with the same reference numeral, and description thereof will be omitted.

First, the roller mechanism 34a according to the first alternate embodiment of the roller mechanism 34 will be described with reference to FIG. 22. The roller mechanism 34a is similar to the roller mechanism 34 with the thrust rotating mechanism 69 (see FIG. 4), but differs in that the thrust rotating mechanism 69 is replaced by a pivoting mechanism (longitudinal locking mechanism) 310.

The pivoting mechanism 310 comprises a mounting member 312 for mounting the pivoting mechanism 310 to the third arm 46 of the robot 16a and a second pivoting member 316 which is pivotally supported by a second pivot shaft 313 of the mounting member 312 through a bearing 314. The base 76 is attached to the bottom of the second pivoting member 316.

The second pivot shaft 313 is orthogonal to the center axis C1 of the third arm 46, and perpendicular to the direction of the first pivot shaft 82. In other words, if the center axis C1, the first pivot shaft 82 and second pivot shaft 313 are geometrically moved in parallel to intersect, these axes would be orthogonal to one another. Therefore, the roller 48 is able to pivot freely in the longitudinal direction because of pivoting mechanism 310.

A rotation regulating member 318 is provided on the top part of the second pivoting member 316, and a small protrusion 320 which protrudes downward from the mounting member 312 is positioned at a recessed region 318a on the top surface of the rotation regulating member 318. The width of small protrusion 320 is slightly smaller than the width of recessed region 318a, and within the range of this difference of width, the second pivoting member 316 can freely rotate about the bearing 314. The small protrusion 320 may also act as the bolt 100 which attaches the mounting member 312 to the third arm 46.

Next, the action when protective layer forming material is applied using the roller mechanism 34a will be described.

As shown in FIG. 23, if the angle of inclination of the surface of the vehicle 14 does not match the orientation of the roller 48, and assuming that the pivoting mechanism 310 is not provided, then only the center point P of the bottom part of the roller 48 will contact the surface of the vehicle 14, and both ends of the roller 48 shown by the double point chain lines will be separated in the vertical direction from the surface of the vehicle 14 by a distance H, or else interference will occur.

However, because the roller mechanism 34a includes the pivoting mechanism 310, the roller 48 rotates about the second pivot shaft 313, and the bottom surface of the roller 48 is automatically kept in close contact with the surface of vehicle 14. Therefore, protective layer forming material can more accurately be applied to the surface of the vehicle 14. The roller 48 does not press the surface of vehicle 14 forcibly. The excessive force is not applied to both the roller 48 and the surface of vehicle 14.

Furthermore, when considering that the first pivoting member 84 (see FIG. 22) is tilted about the first pivot shaft 82, the bottom surface of roller 48 three-dimensionally moves in close contact along the surface of vehicle 14. In other words, the first pivot shaft 82 and second pivot shaft 313 move and act in cooperation, so that the bottom surface of the roller 48 can be kept in close contact with the surface of vehicle 14.

Even if the slope of the surface of vehicle 14 changes continuously (see FIG. 21), similar to the action of the roller mechanism 34, the first pivot shaft 82 and second pivot shaft 313 move and act in cooperation, so that the bottom surface of the roller 48 can be rotated while in contact with the surface of the vehicle 14.

In this manner, even if the angle of inclination of the surface of the vehicle 14 and the direction of the roller 48 do not match, the bottom surface of the roller 48 will automatically be kept in close contact with the surface of the vehicle 14. Therefore, protective layer forming material can accurately be applied to the surface of the vehicle 14, and the detailed setting information is not required for motion teaching of the robot 16a. Therefore, the motion teaching of the robot 16a can be performed simply, and easily, and the time required for motion teaching can be reduced.

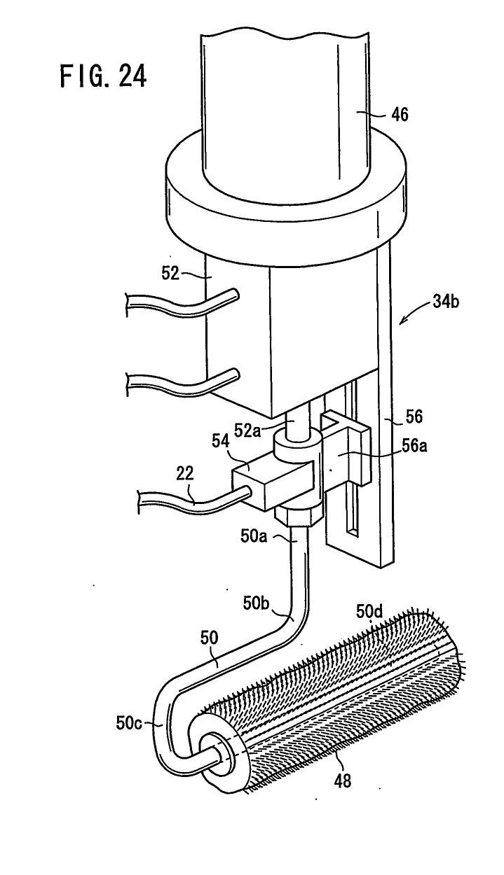

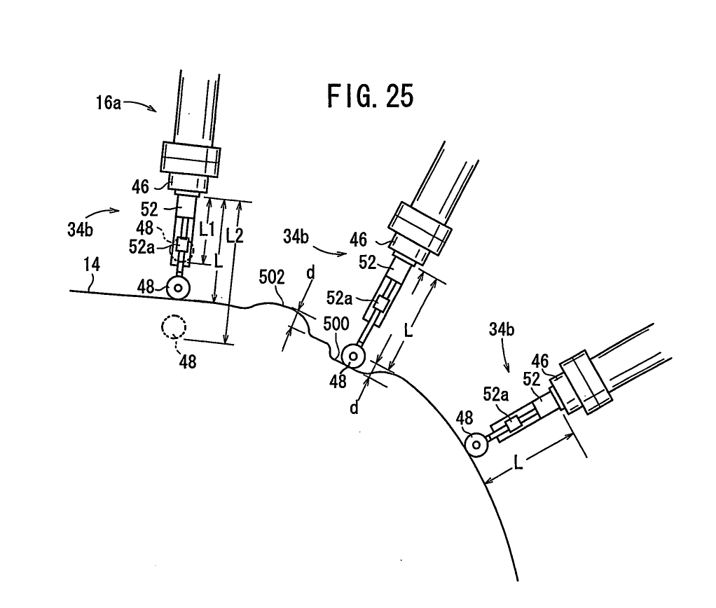

Next, the roller mechanism 34b according to the second alternate embodiment of the roller mechanism 34 will be described with reference to FIG. 24 and FIG. 25.

As shown in FIG. 24, the roller mechanism 34b is connected to the tip end of third arm 46 and comprises the roller 48, a pipe 50 which supports the roller 48, a third pneumatic cylinder (cushion mechanism) 52 which extends and retracts the pipe 50, a connecting member 54 which connects a rod 52a of the third pneumatic cylinder 52 with pipe 50, and a rail 56 which supports the connecting member 54 and guides the connecting member 54 vertically.

One end of the third pneumatic cylinder 52 is fixed onto the third arm 46, and by adjusting the pneumatic pressure of the bottom side and the pneumatic pressure of the rod side, a force can be applied to the rod 52a. The third pneumatic cylinder 52 is able to be driven by a circuit similar to the complex circuit 150 (see FIG. 7) and the pneumatic cylinder circuit 180 (see FIG. 8).

The rod 52a is positioned in alignment with the third arm 46. Furthermore, the rod 52a and the base region 50a of the pipe 50 are connected by the connecting member 54, and in alignment with each other. One end of the rail 56 is fixed to the side surface of the third pneumatic cylinder 52 and the tip end of the third arm 46. One part of the guide support 56a of the rail 56 is fixed onto the connecting member 54, and the connecting member 54 is guided along the rail 56 by the guide support 56a.

The pipe 50 comprises a bend section 50b which is bent at an angle of about 90°, a U-shaped bend section 50c, and a roller mount 50d extending from an end of the bend section 50c. The center axis of the roller mount 50d and the center axis of the rod 52a are orthogonal. The pipe 50 is hollow and the tip end of the roller mount 50d is closed. The roller mount 50d has a plurality of small holes.

An end of a tube 22 is connected to the connecting member 54 such that the tube 22 and the pipe 50 are joined together. Therefore, when protective layer forming material is supplied from the tube 22, the protective layer forming material can pass through the connecting member 54 and the pipe 50 and exude out from the surface of the roller 48.

As shown in FIG. 25 when motion teaching of the robot 16a which is equipped with the roller mechanism 34b is performed, the distance between the third arm 46 of the robot 16a and the surface of the vehicle 14 is maintained at a designated length L. This length L is larger than the length L1 which corresponds to the smallest stroke of the rod 52a, and smaller than the length L2 which corresponds to the largest stroke.

The distance between the third arm 46 and the surface of the vehicle 14 is basically maintained at the length L. It should be appreciated that the distance between the third arm 46 and the surface of the vehicle 14 is variable. For example, if the depth d of the recessed region 500 or the height d of the raised region 502 is small, the operator may not consider the depth d of the shallow, recessed region 500 or the height d of the low, raised region 502. The distance between the third arm 46 and the surface of vehicle 14 may be L+d at the recessed region 500, or L−d at the raised region 502. Since the operator does not have to take the relatively shallow recessed region 500 or the relatively low raised region 502 into consideration, the motion teaching of the robot 16a is easily performed.

Furthermore, a small pressure is applied to the bottom side of the third pneumatic cylinder 52 while the rod side has almost no pressure. Therefore, the rod 52a receives an appropriate force toward the surface of the vehicle 14. The force applied to the third pneumatic cylinder 52 is based on the internal piston diameter and the rod diameter. This adjustment can easily be made by the regulator 182, and may be adjusted to an arbitrary value or continuously during the coating process.

Furthermore, by setting the pressure applied to third pneumatic cylinder 52 to a relatively large value, the roller 48 can be locked so that it cannot move. By locking the roller 48, when the roller 48 is separated from the surface of the vehicle 14 and moved a relatively long distance for instance, the roller 48 will not inadvertently move and can therefore be transported at high-speed for a long distance.

In this manner, the roller 48 is pressed to the surface of the vehicle 14 with an appropriate pressing force, and protective layer forming material can be applied to the surface of vehicle 14. At this time, the roller 48 move up and down along the surface configuration of the vehicle 14. Therefore, the rail 56 and the third pneumatic cylinder 52 have a cushioning effect, and the roller 48 can be kept in close contact with the surface even in the recessed region 500 and the raised region 502, so that protective layer forming material can be applied to the uneven surface of the vehicle 14.

In other words, when the roller 48 passes through the recessed region 500 and the raised region 502, the rod 52a is extended or retracted corresponding to the depth d of the recessed region 500 or the height d of the raised region 502. This extending and retracting action is performed smoothly by the rail 56. Furthermore, the roller 48 is supported by rail 56. Irrespective of the direction from which the roller 48 receives an external force, the force applied to the rod 52a is always in the axial direction.

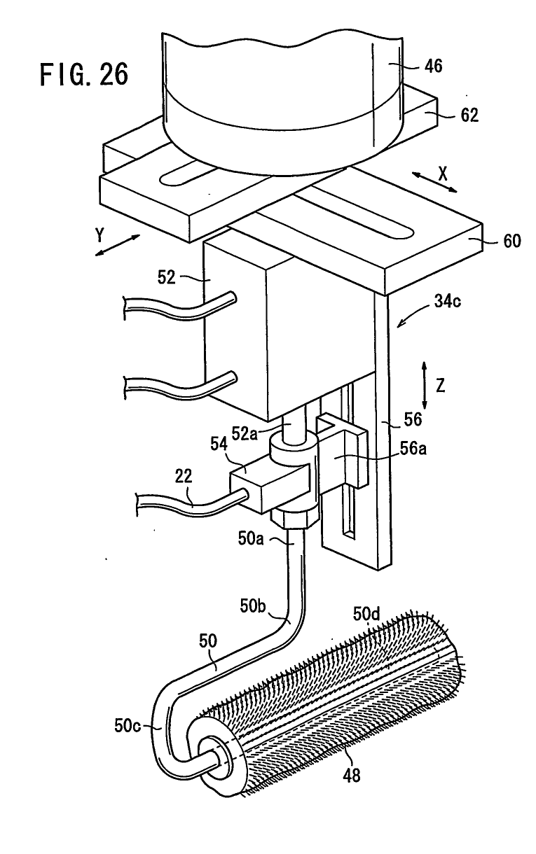

Next, the roller mechanism 34c according to the third alternate embodiment of the roller mechanism 34 will be described with reference to FIG. 26.

As shown in FIG. 26, the roller mechanism 34c according to the third embodiment has two orthogonal shift bases 60 and 62 located between the third pneumatic cylinder 52 and third arm 46 of the roller mechanism 34b. The third pneumatic cylinder 52 is attached to the shift base 60, and is able to slide in the direction of arrow X. The shift base 60 is attached to the shift base 62 and is able to slide in the direction of arrow Y. The shift base 62 is attached to the third arm 46. Assuming that the rod 52a extends and retracts in the direction of the arrow Z, arrows X, Y, and Z are all orthogonal. The arrow Y is parallel to the axial direction of the roller 48.

By placing the shift bases 60 and 62 between the third pneumatic cylinder 52 and the third arm 46, the roller 48 is able to slide in the direction of arrow X and in the direction of arrow Y, and therefore is able to move in any direction on the plane which is orthogonal to arrow Z. When protective layer forming material is applied to the vehicle 14, the force received from the surface of the vehicle 14 on the roller 48 does not necessarily match the direction of arrow Z, and may include a component in the direction of arrow X and the direction of arrow Y.

In this case, the vertical force received from the surface of the vehicle 14 by the shift bases 60 and 62, or in other words the component in the direction of arrow Z, can be absorbed by the rod 52a, and the components of forces in the other directions, direction of arrow X and direction of arrow Y, are absorbed by shift bases 60 and 62. Therefore, excessive external forces will not be applied on the pipe 50 and the rod 52a or the like. Furthermore, excessive reaction forces will not be applied on the surface of the vehicle 14. The rod 52a is supported by the rail 56, but can be more positively supported and protected by the shift bases 60 and 62.

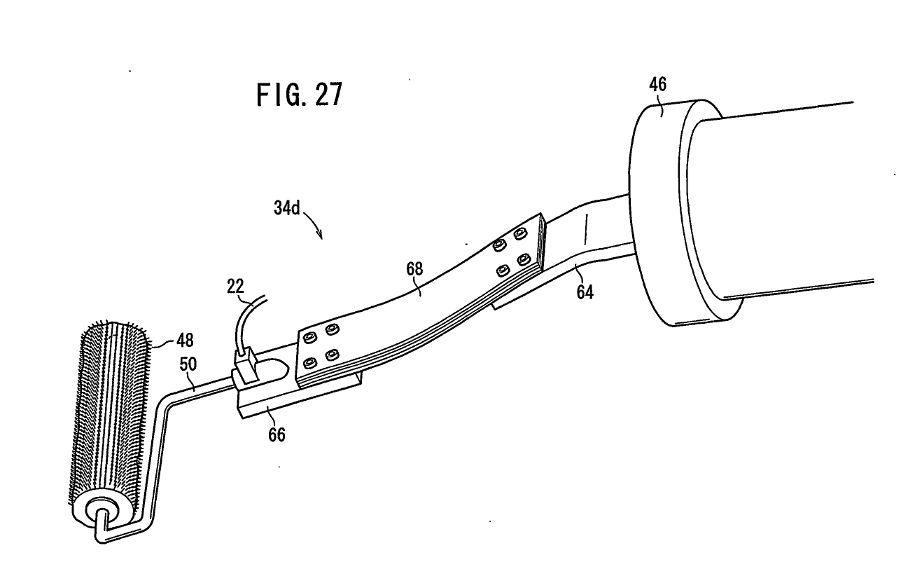

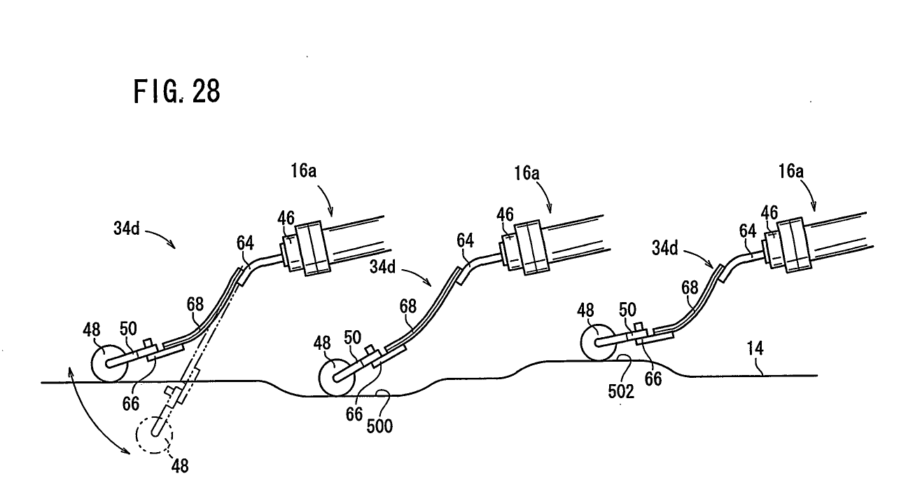

Next, the roller mechanism 34d according to the fourth alternate embodiment of the roller mechanism 34 will be described with reference to FIG. 27 and FIG. 28.

As shown in FIG. 27, the roller mechanism 34d according to the fourth alternate embodiment comprises a first bracket 64 which protrudes from the third arm 46, a second bracket 66 which is connected to the pipe 50, and several layers of plate springs (cushioning mechanism) 68 which connect the first bracket 64 and the second bracket 66 together.

The second bracket 66 is connected to the tube 22, and joined to the pipe 50. The plate spring 68 is secured by bolts to the first bracket 64 and the second bracket 66, and the number of the plate springs 68 may be changed, or plate springs 68 may be replaced. By increasing or decreasing the number of plate springs 68, the force pressing on the external surface of the vehicle 14 can be adjusted (pressing force adjusting mechanism).

The roller 48 is able to elastically shift in the direction orthogonal to the center axis C2 (or in other words the radial direction) because of the effect of the plate springs 68, and therefore has a cushioned effect. Furthermore, by adjusting the number of the plate springs 68, the elastic force can be changed.

As shown in FIG. 28, when motion teaching of the robot 16a which is equipped with the roller mechanism 34d is performed to keep the third arm 46 of the robot 16a at a suitable distance from the surface of vehicle 14, by appropriately bending the plate springs 68, such that the roller 48 can be pressed to the surface of the vehicle 14 by the elastic force of the plate springs 68. At this time, motion teaching of the third arm 46 may be performed such that the third arm 46 is inclined at a certain angle to the surface of vehicle 14. The pressing force that roller 48 presses the vehicle 14 can be adjusted by the amount of bending on plate springs 68.

By teaching the motion of robot 16a in this manner, the roller 48 can be kept in tight contact even with the recessed region 500 and the raised region 502, and the protective layer forming material can reliably be applied to the uneven surface. Furthermore, at the time of motion teaching, it is not necessary to consider the recessed region 500 and the raised region 502 or the like. The motion teaching can be performed easily.

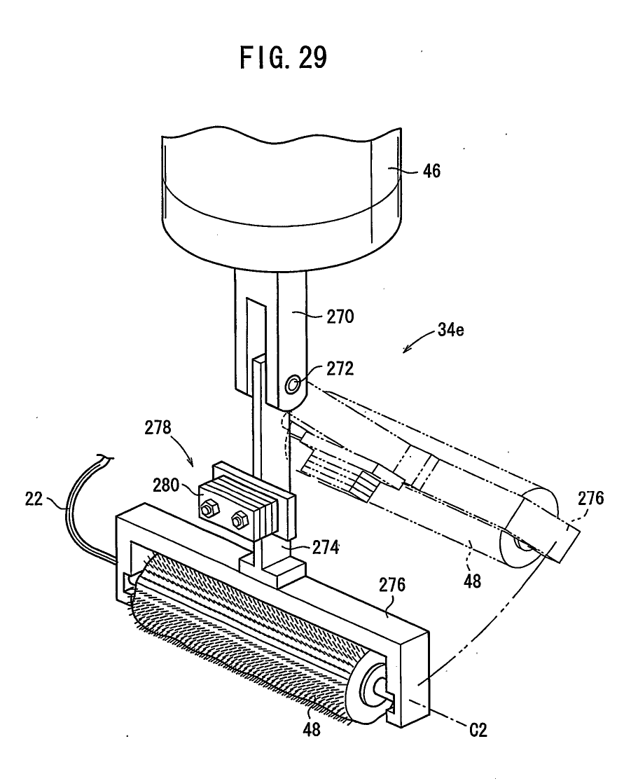

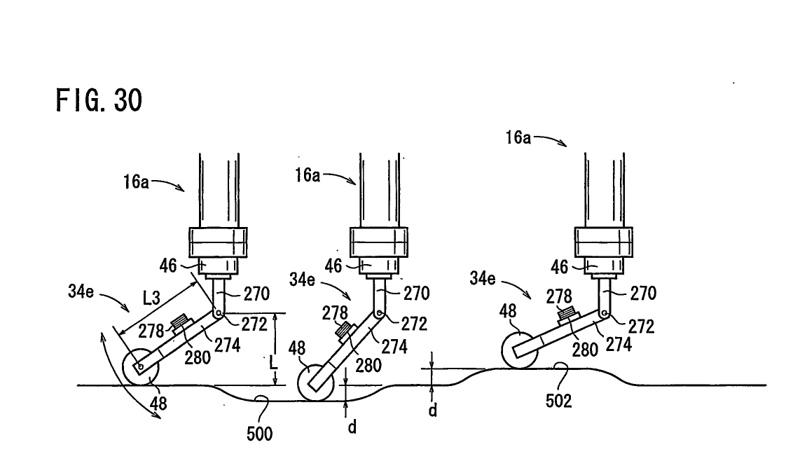

Next, the roller mechanism 34e according to the fifth alternate embodiment of the roller mechanism 34 will be described with reference to FIG. 29 and FIG. 30.

As shown in FIG. 29, the roller mechanism 34e according to the fifth alternate embodiment has a supporting arm 270 which protrudes from the third arm 46, a pivoting arm (cushioned mechanism) 274 pivotally connected to the supporting arm 270 about a pivot shaft (pivoting mechanism) 272 provided at the end of the supporting arm 270, and a holder 276 connected to the pivoting arm 274. Both ends of roller 48 are supported by the holder 276, and a tube 22 is connected to one end of the roller 48 for supplying the coating material into the roller 48. The roller 48 is detachable from the holder 276. The center axis C2 of the roller 48 is in parallel to the pivot shaft 272.

A spindle support (pressing force adjusting mechanism) 278 is disposed near the center of pivoting arm 274, and a plurality of spindle plates 280 are supported on the spindle support 278. Preferably, the spindle plates 280 are made of a material which has a relatively high specific gravity such as iron or lead.

As shown in FIG. 30, when motion teaching of the robot 16a having the roller mechanism 34e is performed, the distance between the third arm 46 of the robot 16a and the surface of the vehicle 14 is a length L. The length L is smaller than the length L3 of the pivoting arm 274.

The distance between the third arm 46 and the surface of the vehicle 14 is basically maintained at the length L. It should be appreciated that the distance between the third arm 46 and the surface of the vehicle 14 is variable. For example, if the depth d of the recessed region 500 or the height d of the raised region 502 is small, the operator may not consider the depth d of the shallow, recessed region 500 or height d of the low, raised region 502. The distance from the third arm 46 to the surface of the vehicle 14 may be L+d at the recessed region 500, or L−d at the raised region 502. The distance varies automatically as the function of the roller mechanism 34e. Since the operator does not have to take the shallow recessed regions 500 and relatively low raised region 502 into consideration, the motion teaching of the robot 16a is easily performed. In this case also, the roller 48 can be kept in close contact with the recessed region 500 and the raised region 502, and the protective layer forming material can reliably be applied to the uneven surface.

In the roller mechanism 34e, the weight of the roller 48 can be effectively utilized as a pressing force to the vehicle 14, and the pressing force can be adjusted by changing the number of spindle plates 280 supported on the spindle support 278. For instance, if the roller 48 is relatively heavy, the number of spindle plates 280 should be reduced. If the roller 48 is relatively light, the number of spindle plates 280 should be increased. By changing the weight of the spindle plates 280, the roller 48 is pressed to the surface of vehicle 14 with an appropriate pressing force, and the protective layer forming material can be applied uniformly to the surface of the vehicle 14. At this time, since the pressing force is applied to the roller 48, the roller 48 pivots along the surface the vehicle 14. Therefore, even in the presence of the recessed region 500 and the raised region 502, the protective layer forming material can be applied uniformly to the uneven surface. In other words, when the roller 48 moves over the recessed region 500 and the raised region 502, the pivoting arm 274 smoothly pivots about the pivot shaft 272 corresponding to the depth d of the recessed region 500 or the height d of the raised region 502. Thus, the roller 48 moves up and down corresponding to the shapes of the raised region 502 and the recessed region 500. The roller 48 is kept in contact with the uneven surface.

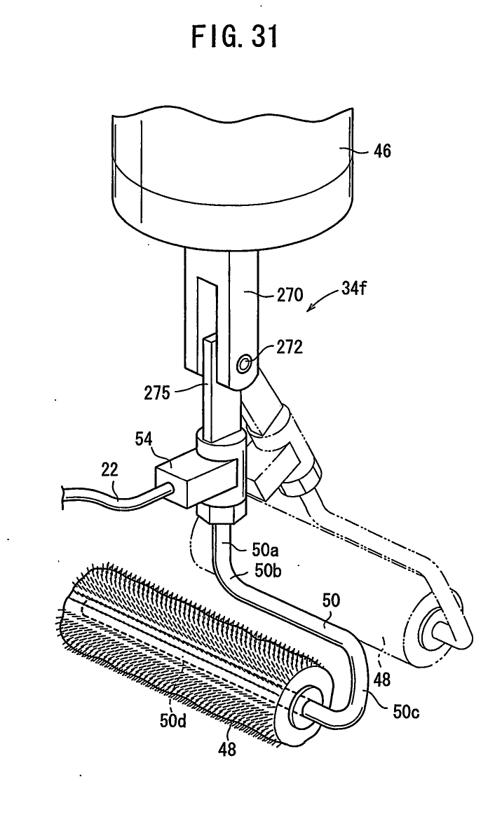

Next, as shown in FIG. 31, the roller mechanism 34f according to the six alternate embodiment of the roller mechanism 34 is similar to roller mechanism 34e with the holder 276, but differs in that the holder 276 is replaced by the pipe 50, and the roller mechanism 34f comprises roller 48, the pipe 50 which supports the roller 48, a pivoting arm 275, and a connecting member 54 which connects the pivoting arm and pipe 50.

In the roller mechanism 34f, the roller 48 can pivot freely in the radial direction, and the advantages similar to those of the roller mechanism 34e can be obtained.

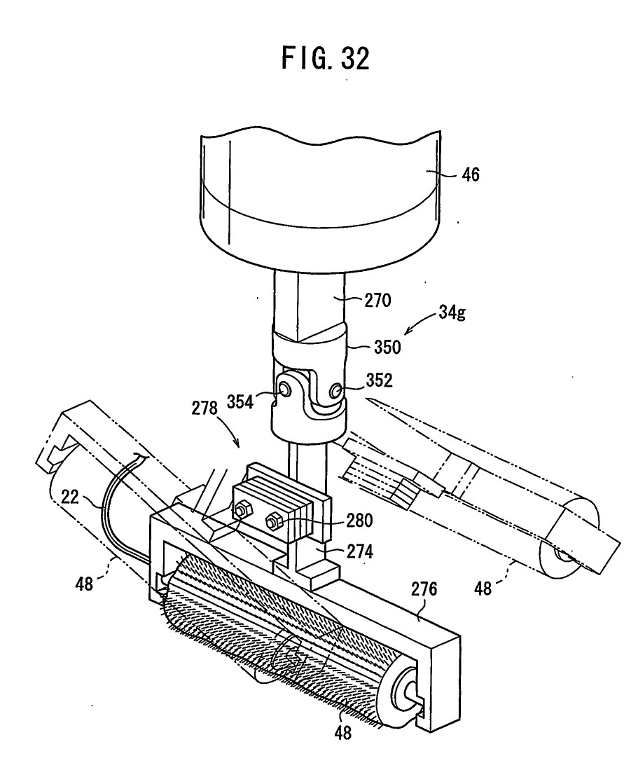

Next, the roller mechanism 34g according to the seventh alternate embodiment of the roller mechanism 34 will be described with reference to FIG. 32.

As shown in FIG. 32, the roller mechanism 34g according to the seventh alternate embodiment is similar to the roller mechanism 34e, but differs in that the pivot shaft 272 is replaced by a universal joint 350. In other words, the supporting arm 270 and the pivoting arm 274 are connected together by the universal joint 350. The universal joint 350 has a pivot shaft 352 which corresponds to the pivot shaft 272, and the pivot shaft 354 is orthogonal to the pivot shaft 352, and the pivoting arm 274 is supported in a manner which can pivot in any direction.

Therefore, the roller 48 can pivot freely in the radial direction or longitudinal direction, i.e., in any direction. This type of roller mechanism 34g has the same advantages as the roller mechanisms 34e and 34f. Since the roller 48 can pivot in the longitudinal direction, even if the surface the vehicle 14 is inclined in the longitudinal direction, the roller 48 can be kept in close contact with the surface of the vehicle 14.

The universal joint 350 may be replaced by a coupling which is used for rotating shafts for motors or the like.

Furthermore, the roller mechanisms 34d, 34e, 34f, and 34g do not require any actuator. The roller mechanisms 34d, 34e, 34f, and 34g are simple, and produced inexpensively.

By teaching the movement of the robot 16a in this manner, the roller 48 is kept in close contact with the recessed region 500 and the raised region 502, and the protective layer forming material can be applied uniformly to the uneven surface. Furthermore, motion teaching is performed without considering the recessed region 500 and the raised region 502, and the motion teaching is easy.

The functions of the roller mechanisms 34-34g may be combined, and used selectively. For instance, the shift bases 60 and 62 (see FIG. 26) of the roller mechanism 34c may be used in the roller mechanism 34d or 34e. Furthermore, the structure which supports roller 48 may use either the pipe 50 (see FIG. 24) or the holder 276 (see FIG. 29).

Furthermore, the components which function as a cushion (the first pneumatic cylinder 78, second pneumatic cylinder 82, third pneumatic cylinder 52, plate springs 68, pivoting arm 274, or the like) for the roller 48 in any of the roller mechanisms 34-34g, may also have an appropriate damping mechanism to control vibration.

Furthermore, the roller mechanisms 34-34g have a structure which presses the roller 48 to the surface of the vehicle 14, and raises and lowers the roller 48 corresponding to recessed and raised regions. The roller 48 is kept in close contact with the uneven external surface of the vehicle 14, and the protective layer forming material can be applied appropriately.

The coating system of the present invention is not restricted to the above embodiments, and various forms may of course be taken without deviating from the essence of the present invention.

1. A coating system for forming a protective layer, comprising:
a coating device which is movable according to information taught by an operator, and disposed in adjacent to a transport line for an object to be coated;
a roller mechanism having a roller and a cushion mechanism, said roller being connected to said coating device; and
a supply mechanism which supplies liquid material to said roller,
wherein a force is applied to said roller through said cushion mechanism to move said roller, corresponding to unevenness of an external surface of said object for coating said object with said liquid material, and said liquid material is dried to form a peelable protective layer on said object.

2. The system according to claim 1, wherein said coating device comprises a robot, and said object to be coated is a vehicle.

3. The system according to claim 1, wherein said roller mechanism has a force adjusting mechanism for adjusting a force applied to said roller on said external surface.

4. The system according to claim 1, wherein said roller mechanism has a mechanism for pivoting said roller freely.

5. The system according to claim 4, wherein said pivoting mechanism pivots said roller freely in a radial direction of said roller.

6. The system according to claim 1, wherein said roller mechanism is equipped with pneumatic cylinders as said cushion mechanism, and said roller is elastically pressed to the external surface of said object to be coated while said roller is moved corresponding to the unevenness of said external surface.

7. The system according to claim 6, further comprising regulators for adjusting pneumatic pressure applied to said pneumatic cylinders.

8. The system according to claim 7, wherein each axis of rods of said pneumatic cylinders is orthogonal to an axis of said roller.

9. The system according to claim 7, wherein said pneumatic cylinders comprise a first pneumatic cylinder and a second pneumatic cylinder;
said roller is pivotably connected to a pivoting member, said roller pivoting freely in a radial direction; and
said first pneumatic cylinder and said second pneumatic cylinder apply forces to said pivoting member in opposite directions, respectively.

10. The system according to claim 1, further comprising a controller for controlling said coating device and said roller mechanism;
said roller being connected to a pivoting member and pivoting freely in a radial direction;
said roller mechanism having a first pneumatic cylinder and a second pneumatic cylinder which cause said pivoting member to pivot in opposite directions, respectively;
said controller controlling, corresponding to the movement of said coating device, by switching between first control and second control;
said first control generating a first drive force for pressing a rod of at least one of said first pneumatic cylinder and said second pneumatic cylinder in the direction in which said pivoting member to pivot, and
said second control generating a second drive force for separating said rod from said pivoting member.

11. The system according to claim 10, wherein said controller provides third control, corresponding to the movement of said coating device, said third control generating a third drive force in both of said first pneumatic cylinder and said second pneumatic cylinder for fixing said pivoting member, and
said third drive force is larger than said first drive force.

12. The system according to claim 10, wherein said controller causes said rod to retract in said first control.

13. The system according to claim 10, further comprising:
a first drive setting component controlled by said controller and setting a drive force and a drive direction of said first pneumatic cylinder; and
a second drive setting component is controlled by said controller and sets a drive force and a drive direction of said second pneumatic cylinder.

14. The system according to claim 10, further comprising regulators for setting a pneumatic pressure for generating said first drive force and/or said second drive force on at least one of said first pneumatic cylinder and said second pneumatic cylinder.

15. The system according to claim 1, wherein said roller mechanism has a thrust rotating mechanism for rotating said roller about an axis, which is orthogonal to an axis of said roller.

16. The system according to claim 15, wherein said roller mechanism has a pivoting mechanism for pivoting said roller in a radial direction.

17. The system according to claim 1, wherein said roller mechanism has a longitudinal pivoting mechanism for pivoting said roller in a longitudinal direction.

18. The system according to claim 17, wherein said roller mechanism has a pivoting mechanism for pivoting said roller in a radial direction.

19. The system according to claim 1, wherein said liquid material is acrylic base copolymer.
